(19) United States
(12) Patent Application Publication
(10) Pub. No.: US 2016/0103927 A1
(43) Pub. Date: Apr. 14, 2016

(54) AUTOMATIC SIZING OF WRAP PACKAGES OF CARDS

(71) Applicant: Wrap Media, LLC, San Francisco, CA (US)

(72) Inventors: John M. GARRIS, San Francisco, CA (US); Jared L. FICKLIN, Austin, TX (US); Ian McFARLAND, San Francisco, CA (US)

(21) Appl. No.: 14/873,979

(22) Filed: Oct. 2, 2015

Related U.S. Application Data
(60) Provisional application No. 62/062,056, filed on Oct. 9, 2014.
(60) Provisional application No. 62/062,061, filed on Oct. 9, 2014.
(60) Provisional application No. 62/144,083, filed on Apr. 7, 2015.
(60) Provisional application No. 62/191,079, filed on Jul. 10, 2015.
(60) Provisional application No. 62/084,171, filed on Nov. 25, 2014.
(60) Provisional application No. 62/091,866, filed on Dec. 15, 2014.
(60) Provisional application No. 62/114,675, filed on Feb. 11, 2015.
(60) Provisional application No. 62/133,574, filed on Mar. 16, 2015.
(60) Provisional application No. 62/195,642, filed on Jul. 22, 2015.
(60) Provisional application No. 62/210,585, filed on Aug. 27, 2015.
(60) Provisional application No. 62/145,360, filed on Apr. 9, 2015.
(60) Provisional application No. 62/170,438, filed on Jun. 3, 2015.
(60) Provisional application No. 62/170,569, filed on Jun. 3, 2015.
(60) Provisional application No. 62/193,830, filed on Jul. 17, 2015.

(51) Int. Cl. G06F 17/30; G06F 17/22; G06F 17/21

(52) U.S. Cl. CPC G06F 17/30905; G06F 17/212; G06F 17/2288

(57) ABSTRACT

A device requests a wrap package from a server. The wrap package has an original size and aspect ratio. The device automatically determines a new card size to fit its viewport having the same aspect ratio and renders each card upon its display screen. All spatial relationships between components in each card are maintained in the new card size, preserving the original impression. A server that stores a wrap package resamples at least one image on at least one card before delivering the wrap package to the device. Once the request is received from the device, the server is aware of the type of device, the optimal card size and the resolution of that device. A new size for the image is determined using current card size and optimal card size. The image is resampled to produce a new image having an appropriate size and resolution for the device.

### CROSS REFERENCE TO RELATED APPLICATIONS

This application claims the benefit of U.S. Provisional Patent Application No. 62/062,056 (P001P) and 62/062,061 (P002P), both filed on Oct. 9, 2014 and both entitled “Wrap Package of Cards for Conveying a Narrative With Media Content, Providing Application Functionality, and Engaging Users in E-Commerce”. This application further claims the benefit of U.S. Provisional Application No. 62/144,083 (P007P), entitled “Autosizing for Wrap Packages”, filed Apr. 7, 2015 and U.S. Provisional Application 62/191,079 (P007P2) entitled “Automatic Sizing of Wrap Packages of Cards”, filed Jul. 10, 2015. This application further claims priority of U.S. Provisional Patent Application No. 62/084,171 (P005P), filed Nov. 25, 2014; 62/091,866 (P005P2), filed Dec. 15, 2014; 62/114,675 (P005P3), filed Feb. 11, 2015, 62/133,574 (P005P4) filed Mar. 16, 2015, 62/195,642 (P005P5) filed Jul. 22, 2015; and 62/210,585 (P005P6), filed Aug. 27, 2015, each entitled “Card Based Package for Distributing Electronic Media and Services. In addition, this application claims the benefit of U.S. Provisional Application Nos. 62/145,360 (P015P), filed Apr. 9, 2015; 62/170,438 (P016P2) filed Jun. 3, 2015; 62/170,569 (P018P) filed Jun. 3, 2015; and 62/193,830 (P019P), filed Jul. 17, 2015. Each of these priority applications, including any appendices and/or exhibits, is incorporated herein by reference for all purposes.

### BACKGROUND

This invention relates to automatically sizing an electronic document when displayed, and more particularly, to automatically sizing a card within a wrap package, or the wrap package itself, for display upon any of a variety of screen sizes.

For many years, the concept of fluid layout has been the dominant view for how Web pages, electronic documents, and other electronic images and collections of objects should be adjusted as the screen size (or available viewport) changes. Also known as responsiveness, this concept is the basis of HTML and dictates how components of a Web page (for example) should be moved around fluidly (or laid out) as the screen size (or window) within which the Web page changes. As the window is made smaller or larger, components within the window are resized and components are moved in relation to one another, all to accommodate the change in screen size. Historically, this concept has been used since the early days of the Internet in order to attempt to accommodate any possible screen size. This approach, however, is now less than ideal. Screens on modern computing devices are both significantly larger and smaller compared to the early days of the Web. For example, with advances in flat panel technology, screen sizes of 50, 60, 70 inches and beyond are now common for smart TVs that can also be used as computer displays. On the opposite end of the spectrum, the screen sizes for mobile devices, such as smartphones and tablets, are now very small, measuring no more than several inches.

Unfortunately, use of fluid layout often means that the original impression intended by the author of a particular image (such as a painting, photograph, graphic design, advertisement, Web page, etc.) may be lost. The impression of an image is a time-honored graphic arts technique used by the painter, graphic artist, or Web designer that conveys certain feelings and emotions based upon the layout of components within the image. For example, consider a painting of a woman with a lit face gazing down upon an apple; this painting makes a particular impression upon the viewer. If a displayed image of the original painting is resized to be smaller or larger, to be in landscape mode rather than portrait mode, or to have a different aspect ratio, and the apple moves with respect to the woman's gaze such that she no longer gazes upon the apple, then the original impression intended by the author is lost.

In a more modern example, consider an advertisement on a Web page from a clothing retailer in which a woman in a long dress gazes toward the “BUY” button. If the image is resized, and the “BUY” button is moved with respect to the woman's gaze, then again, the impression is lost. Unfortunately, resizing of images, whether it is a user adjusting a browser window, a user “pinching” or “expanding” a window on a mobile phone, or an original image being resized as it is sent to a television screen, a desktop computer, a laptop computer or mobile phone (all with different screen sizes), can be common.

Other techniques to address this problem are not optimal or have been unsuccessful. For example, if a graphic designer of an advertisement for a Web page knows that the advertisement will likely be seen on three specific, known screen sizes (e.g., a specific desktop computer screen, laptop computer screen and mobile phone screen), then the designer may design three different layouts for each of the three specific screen sizes in order to preserve his or her artistic impression across all three devices. Not only is this approach time-consuming and expensive, but also it fails to scale to other screen sizes. With the ever-increasing number of devices with different screen sizes, this approach is not practical and is less than ideal.

Another approach is to resize bit map files, such as files in the PNG format. As a PNG file is resized, it does not use fluid layout, which preserves the original relationship between images in the file. The problem with bit maps, however, is that they are simply images and do not contain any functionality such as active text components or data entry components, Internet links, functionality buttons, headers, etc., and they cannot be searched. And, while bit maps are scalable, they are made up of pixels, and not the normal constituents of a functional Web page.

In the above-listed non-prior art related patent applications, the concept of a new media type referred to as wrap packages is described. A wrap package is a collection of cards that are each selectively authored to include (i) one or more types of media content such as text, images, photos, video, etc., (ii) application functionality and/or (iii) e-commerce related services. The cards in a wrap are also typically authored to define one or more linear sequence(s) when consumed. With wrap packages, an author thus has the ability to select media content, combined with application-like and website functionality, and combine them all into an elegant, card-based, narrative. As a result, the author can create compelling stories using media, interwoven with interactive functionality and/or e-commerce services. Wrap packages are, therefore, ideal, but not necessarily limited to, delivering a unique, interactive, “book-like”, experience over the mobile web, which previously has been not possible.

As wrap packages increase in popularity and become broadly distributed, they will likely be displayed on a wide variety of different computing devices having a different screen sizes. A technique for preserving the original impression of such wrap packages, so that a given wrap package always looks the same when displayed, regardless of the screen size, is therefore needed.

### SUMMARY

The present invention is directed to a technique for automatically sizing a wrap package of cards such that the individual cards may be displayed upon any of a variety of screen sizes while preserving the original impression created by the designer of the wrap package.

The present invention, unlike fluid layout, protects the original impression across all screen sizes, thus preserving the purpose, emotions and feelings desired by the creator of the wrap package. Using the present invention, all the primitive components of a particular card (such as text, header, images, functionality buttons, links, etc.), still remain individual components (with their own unique look, feel and functionality) and they maintain their spatial relationship to one another no matter the screen size in which the card is displayed. For example, if a particular “BUY” button is always one third of the way up from the bottom of a card and one quarter of the way in from the right hand side, it will always have that same relative spatial position no matter the viewing window of a particular display device.

The present invention protects the original impression by maintaining the same aspect ratio for any potential viewing or consuming device. For example, a wrap package of cards is created using one particular portrait-style aspect ratio, and this particular aspect ratio is maintained for the wrap package (and for each of its cards) on whichever display device (such as a wide variety of mobile phones, tablet computers, laptop computers, desktop computers, etc.) the wrap package is distributed to and consumed on.

In a first embodiment, a computing device such as a mobile phone, tablet computer, laptop, or other display device requests a wrap package of cards from a computer server. The wrap package of cards has an original size and aspect ratio, which size may often be different from a size that is optimal for the viewport on the requesting device. On the consuming device, a runtime viewer determines a new card size having the same aspect ratio and then renders each card of the wrap package upon its display screen. All of the spatial relationships between components in each card are maintained in the new card size, thus preserving the original impression. In various embodiments, the run time viewer can globally scale each card larger or smaller or move and scale each component of the card on a component-by-component basis. The runtime viewer can also either be included in a native wrap application already on the consuming device or downloaded with the wrap package in response to the request.

In a second embodiment, a computer server that stores a wrap package of cards is further configured to resample at least one image within the cards. With this embodiment, a request from a consuming device for a wrap package will also include either an identification of the actual device or the class of device, including screen size. With this information, the server determines the optimal card size that should be displayed on the requesting device and the resolution of that device by (i) ascertaining a ratio between a new card size optimal for the size of the requesting device and the current card size, and based upon that ratio, (ii) determining the new size for the at least one image. The image may then be resampled based on the ratio to produce a new image having an appropriate size and resolution for the requesting device. Thus, when the wrap package including the resampled image is delivered to the computing device the resampled image need not be resized and is already the correct size and has the correct resolution. As a result, once the cards and its other components are resized, all of the spatial relationships between the components in the card (including the resampled image sent to the card) are again maintained in the new card size, thus preserving the original impression. By resampling the image on the computer server, unneeded information in the image need not be sent to the computing device, preserving bandwidth and allowing a faster transfer.

In a third embodiment, resampling of the image is viewed from the perspective of the computing device. The computing device requests a wrap package of cards to be displayed, and via that request the computer server is able to determine the viewport of the device and its screen resolution. The image is resampled at the computer server as described in the second embodiment and then sent to the computing device. When the wrap package of cards is rendered within the viewport of the computing device the image already has the correct size and screen resolution because of processing on the computer server. All of the spatial relationships between components (including the image) on cards of the wrap package are thus maintained during the rendering.

### BRIEF DESCRIPTION OF THE DRAWINGS

The invention and the advantages thereof, may best be understood by reference to the following description taken in conjunction with the accompanying drawings in which:

FIG. 1 is a diagram illustrating a wrap package layout that includes a plurality of cards threaded together so as to be viewable in linear arrays in accordance with the principles of the present invention.

FIG. 2 is a diagram depicting the design, functionality and data integration capabilities of a representative card in a digital companion wrap package according to the principles of the present invention.

FIG. 3 is a diagram illustrating the media content and distribution model for distributing digital companion wrap packages in accordance with the principles of the present invention.

FIG. 4 is a block diagram of a representative system for authoring, storing, distributing and consuming wrap packages in accordance with the principles of the present invention.

FIG. 5 diagrammatically illustrates selected components associated with defining and rendering a representative wrap package.

FIG. 6 diagrammatically illustrates the structure of a representative wrap descriptor.

FIG. 7 illustrates another embodiment of an environment for the creation and distribution of wrap packages.

FIG. 8 is a representative process suitable for delivering wrap packages.

FIG. 9 is an alternative, browser based process for requesting, delivering and rendering wrap packages.

FIG. 10 is a process of generating and updating the view of the wrap during rendering.

FIG. 11 is a high-level flow diagram illustrating one embodiment by which a wrap package is created and delivered.

FIG. 12 is a flow diagram describing an embodiment by which a card of a wrap package is automatically sized for a particular device.

FIG. 13 illustrates movement of an image in order to preserve an impression between different card sizes.

FIG. 14 shows a card from a wrap package displayed on a number of different devices.

FIG. 15 is a flow diagram describing an implementation of step 416 of FIG. 11 in which an image in the wrap package is resampled on the wrap server before delivery to the target device.

FIG. 16 is an example of a portion of an image that appears on a card within a wrap package.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

The above-listed related applications describe a new media content type, referred to as “wrap packages”. The terms “wrap” or “package” are interchangeably used herein to refer to wrap packages.

A wrap package is a collection of cards that are each selectively authored to include (i) one or more types of media content such as text, images, photos, video, etc., (ii) application functionality and/or (iii) e-commerce related services. The cards in a wrap are also typically authored to define one or more linear sequence(s) when consumed. With wrap packages, an author thus has the ability to select media content, combined with application-like and website functionality, and combine them all into an elegant, card-based, narrative. As a result, the author can create compelling stories using media, interwoven with interactive functionality and/or e-commerce services. Wrap packages are, therefore, ideal, but not necessarily limited to, delivering a unique, interactive, “book-like”, experience to the mobile web, which previously has been not possible.

The cards of wrap packages are navigation metaphors. Each card can be authored to group related information that can be easily consumed within a user interface experience by swipe (or other simple gesture) navigation from card-to-card.

Cards have a visual representation intended to evoke similarities to their physical counterparts. They have a fixed portrait aspect ratio that makes them ideally current mobile computing devices as well as easy to scale up to and arrange to fit other display form factors, such as provided on laptop and desktop computers as well as smart TVs. The physical card metaphor can also extend to the interactive behavior of cards in a wrap, as the user can use gestures that evoke the “flipping” of cards in a deck or bound booklet to navigate between them.

In addition, each card in a wrap has defined content that is displayed in a predefined layout. In general, the cards in a wrap have the same size and aspect ratio. The aspect ratio is preferably device independent and is preferably maintained regardless of device orientation and/or display window size.

Cards are like containers for holding and distributing media content, such as text, images, photos, audio, video and the like. In addition, cards may also contain or hold executable objects that provide or enable real-time features, such as application functionality (i.e., the ability to schedule appointments, engage in online chats or conversations) and support e-commerce related services (i.e., the ability to purchase goods and/or services). The multimedia content and/or interactive services contained by any given card can be determined entirely in advance or as late as the moment the wrap is consumed by the end-user. Such media content and executable objects are sometimes referred to herein as card “assets.”

Cards, however, can differ from their physical counter-parts in ways that provide for unique presentations of content or the aforementioned application functionality and/or e-commerce services. For example, a gallery card provides the ability to present an expanded amount of content in a vertically stacked orientation such that the overall length (i.e., the number of cards in a horizontal sequence) of the wrap is not affected by the amount of content in the wrap. This aids in navigation since the user can flip to the previous or next card regardless of their current position in the gallery.

Wrap packages are delivered and rendered in a browser as a sharable and savable message. Wrap packages thus provides an app-like user experience that is delivered as a live, interactive, message from a cloud-based platform, using for example, the Software as a Service (SaaS) model. A wrap is thus a portable container of multimedia content, and interactive services, designed for ease of delivery, exchange, and consumption.

Wrap packages are also consumable anywhere, meaning they have the ability to be resolved and displayed on just about any type of device (mobile phones, laptops, tablets, wearable computing devices such as smart watches, desktop computers, smart. TVs, etc.), regardless of the platform (e.g., iOS, Android, Microsoft, etc.). Wrap packages are thus platform and device independent. Wraps do not have to be written for any specific platform, such as iOS or Android, or for any specific device or class of devices (e.g. smart phones, tablets, desktops, etc.).

Wrap packages are thus a mobile-first marketing and commerce platform that ideally provides a beautiful world of storytelling in bite-size moments that get and hold attention. In addition, the unique characteristics of (i) authoring once and running on almost any device, regardless of the operating system or the type and (ii) the ability to easily distribute wrap packages similar to messages, together are a powerful construct that potentially can make the use of wrap packages near universal.

By creating wrap packages, businesses and other organizations can simply and cheaply create, distribute, and manage storytelling mobile web user experiences, app like functionality and e-commerce, all in the context of wrap packages delivered directly to consumers. Where businesses used to have to build destinations (websites) or use monolithic systems (apps), they can now provide consumers, particularly mobile device users, with a user experience that delivers the content they want combined with a complementary palette of functions and/or e-commerce related services.

Wrap packages thus solves a number of current problem with the mobile web. Unlike web sites, wrap packages are easy to consume on mobile devices and offer the opportunity to create compelling narratives and user experiences. In addition, the ability to incorporate app-like functionality into wraps provides a multi-function app-like experience, without having to develop an app, be in an app, download an app, or open several apps.

The uniqueness of wrap packages creates opportunities for business and other organizations alike to innovate and improve marketing efforts, customer support, and user experiences in ways previously not possible, because an enabling interface and platform did not exist. Wrap packages can thus potentially define the next generation interactive web paradigm, particularly for mobile, although for desktop and other types of devices as well.

The cards of the wrap packages are ideally authored in one or more linear sequences so that a book-like narrative unfolds, not only through the cards themselves, but also by the transition between the cards, as they are sequentially browsed. In addition, the wrap packages are portable objects that may exist within a social feed or within a custom application. Wrap packages are also readily distributed, similar to electronic messages, through e-mail, messaging, social-media, or via a variety of other electronic communication platforms. As a result, wrap packages are consumable, sharable and savable objects. As the cards are browsed in the one or more linear sequences during consumption, the user experiences the unfolding of the authored narrative, including the defined media content interwoven with the complementary application functionality and/or e-commerce related services. As a result, the entire user experience including any application functionality and/or e-commerce related services is substantially contained within the context of the wrap package itself, typically (but not necessarily) without the need to navigate to other sites.

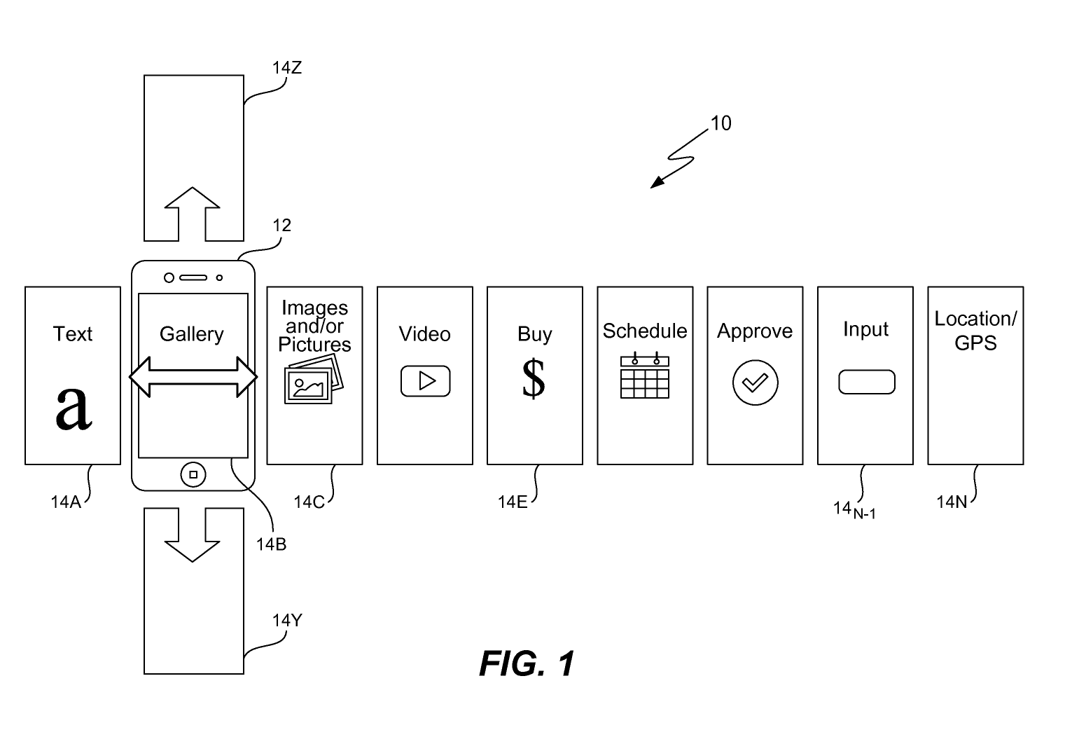

Referring to FIG. 1, a diagram of a non-exclusive embodiment of a wrap package 10 viewable on a computing device 12 is illustrated. The wrap package 10 includes a plurality of cards 14 that are threaded together so as to enable browsing by swiping in one or more linear sequences. Any of the cards 14 may optionally include various types of media, such as text, images or photos, audio, video, a live or streaming feed of media, 3-D objects, or content from other wrap packages (not illustrated). Any of the cards 14 may also optionally provide application functionality, such as the ability to receive input data or display dynamically generated data, a calendar for scheduling or booking appointments or making reservations for goods and/or services, location/GPS, etc. In addition, any of the cards 14 may optionally provide or support e-commerce services, such as the ability to browse products in a catalog, communicate with an online sales representative, and/or purchase product(s).

By way of example, in the schematically illustrated wrap package 10, card 14_{A} includes text, card 14_{B} presents a gallery, card 14_{C} includes images or pictures, card 14_{D} includes a video, card 14_{E} includes e-commerce related service(s), card 14_{F} includes a calendar function for scheduling appointments and/or booking reservations, card 14_{G} includes a user approval function, 14ₙ₋₁ includes a data entry function, card 14_{N} includes location or GPS services, etc.

On computing devices with touch sensitive screens, the cards 14 of wrap packages 10 can be navigated linearly by swiping or by using other suitable interfaces, such as a stylus or pen. In devices without a touch sensitive screen, alternative user interfaces are provided to facilitate transition (e.g., flipping) from one card to the next. In the context of the present application, the terms “swipe-browsing” or “swiping” is intended to mean the navigation from one card to an adjacent next card. With devices with touch sensitive screens, swipe browsing is typically implemented by the sliding of a finger or other input device across the display. With devices without touch-sensitive screens, other navigation tools such as a mouse, keyboard or remote control, can be used for swipe browsing. When a swipe is performed, the content of the next card in the sequence is displayed. For example, by swiping either right to left or vice versa, the next card, depending on the swipe direction, in the horizontal sequence is displayed. Similarly, by swiping up and/or down, the next card in either the up or down sequence is displayed. Thus, the user experience when consuming a wrap package is the wrap package itself (as opposed to a remote web site for example), viewable via a swipe-able interface.

Additionally, some cards may also include one or more embedded link(s) that, when selected, enable navigation to either a non-adjacent card not in linear sequence or to another wrap package, a web page or some other location entirely outside of the wrap package.

It should be noted that the particular layout of cards 14 in the wrap package 10 illustrated in FIG. 1 is merely illustrative. Both the number of rows and/or columns, and the number of sequential cards 14 within any given row or column, may vary widely as appropriate to deliver the desired user experience, narrative, content, functionality and services of the wrap package 10.

With gallery cards, such as card 14_{B} of FIG. 1, swiping allows for the scrolling through of the contents of a card 14, which are typically too voluminous to be displayed within the size of a fixed screen display, such as that provided on a mobile phone. In an illustrative example, a particular wrap package 10 may include a plurality of cards organized in a horizontal sequence. By swiping right to left or vice versa, the next card 14 or the previous card 14 in the horizontal sequence is displayed. In the vertical direction, however, one or more selected cards 14_{B} may be configured in the gallery format, allowing the viewer to scroll up or down by swiping through media content of the gallery. In an illustrative but non-exclusive example, a wrap package 10 authored and distributed by a car rental business may include a horizontal sequence of cards 10, each dedicated to a category of information pertinent to a traveler (i.e., cards dedicated to local hotels, restaurants, local tourist attractions respectively). By swiping up or down for a given card, relevant material within each category is displayed in a gallery format. For instance by swiping up or down the hotel card (not illustrated), a gallery of a number of local hotels is displayed. In variations of the gallery card format, the behavior invoked by an up or down swipe may differ. For example, swiping up or down my result in a continuous “rolling” of the content of the gallery card. In other embodiments, an up or down swipe may result in a “snap” action with the next item of content appearing after the snap, for example, as illustrated as cards 14Y and 14Z in FIG. 1.

The wrap package 10 is identified, as described in more detail below, through the use of a unique identifier (wrap ID 42) assigned to the package 10. By way of example, the wrap ID 42 may take the form of a Uniform Resource Identifier (URL). As such, the wrap ID may thus be provided as a link, which can readily be used to effectively send or retrieve the wrap package. That is, the wrap package may effectively be “sent” to a potential viewer as a link using any of the wide variety of mechanism that can currently—or in the future—be used to send a link or convey the URL. By way of example, this may include e-mail messages, text messages, SMS messages, via a Twitter tweet, as a post on social media such as Facebook, etc., discussion forums, walls or the like, as a link embedded in a document, an image, or a web page or any other media type, in a blog or microblog (e.g. Tumblr), or any other messaging or electronic content distribution mechanism or communication platform currently known or developed in the future.

Wrap packages are therefore significantly different and more powerful than web sites. For example with wrap packages, they can be consumed “on the spot” where it is located (i.e., when delivered to a mobile device for example). In contrast with the selection of a banner ad appearing within a web site, where the viewer is taken to a new web page that is not (a) necessarily designed for mobile devices and (b) is self-navigating, making it very difficult for a narrative to be conveyed. As a result, the user experience, particularly on mobile devices, may be very poor. Hence, the friction of providing a compelling user experience with wrap packages is far less than with web site.

The cards 14 of a wrap 10 can be displayed on the screen of virtually any type of computing device. It should be appreciated that the card metaphor is particularly well suited for use on mobile devices such as smart phones, tablet computers, etc., which makes the format particularly powerful for authors interested in developing content tailored for mobile devices. By delivering wrap packages 10 to mobile devices, users and potential customers can be won over at their point of intimacy, where they spend their time and consciousness. Wrap packages thus allow authors, merchants and other content providers to create compelling narratives and provide ongoing application functionality and/or e-commerce support directly delivered anytime and anywhere to users, transforming their mobile devices into a powerful business tool that enhances mobile engagement and relationships. As a result, higher customer satisfaction, better brand engagement, and a higher conversion (i.e., click-through rates) and repeat e-commerce related activity compared to other forms of after sale promotions and merchandising will likely result.

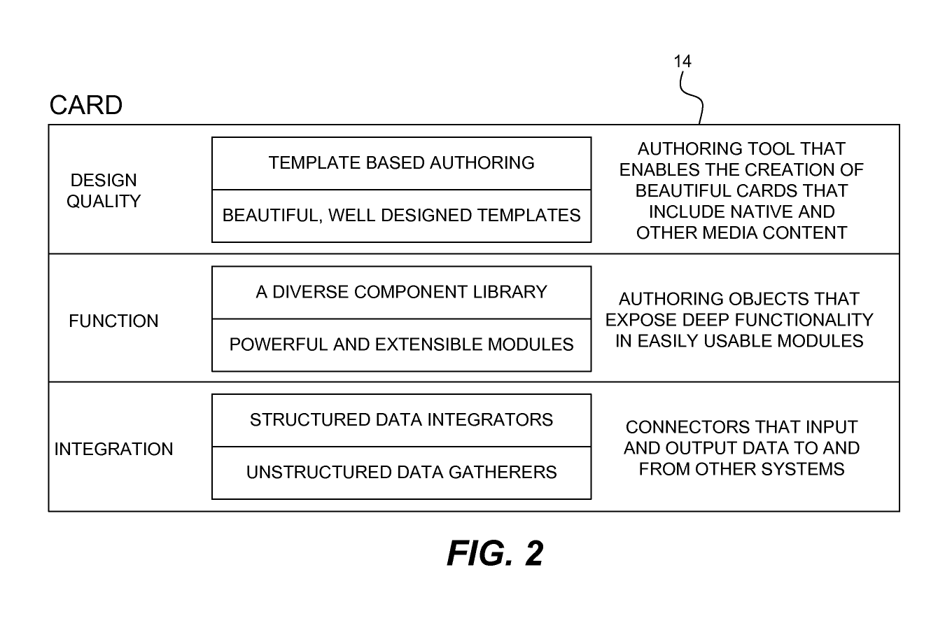

Referring to FIG. 2, a diagram depicting the design, functionality and data integration capabilities of a representative card 14 in a wrap package 10 is shown.

By using card templates, authoring tools and media collaboration tools, beautiful, content-rich, cards 14 may be created either by automation or by individuals with even minimal design skills and experience. As such, the author, either a person or an automated process, has the ability to easily create beautiful content-rich cards 14 that can selectively include text, images, photos, and other media similar to PDF files, but optionally, with the added benefit of additional application functionality and/or e-commerce related services, either embedded in the same card 14, or other cards 14, in the wrap package 10. In the automated authoring embodiments, the content of a card 14 can be populated by a data processing system that automatically uploads predefined content into various defined fields of a card template.

By authoring (i) the horizontal and/or vertical sequence order for swipe-browsing the cards 14, (ii) the media content in each card 14, (iii) application functionality and/or (iv) the e-commerce services for each card 14, it is possible to author Wrap packages 10 that are content-rich, highly interactive, and that define a palette of services, functions and experiences related to the wrap package 10, all within the context of a story book-like narrative that unfolds as the cards 14 are browsed in their sequence order(s).

In addition, the use of component libraries and the authoring tools allow for the authoring of cards 14 with a diverse, easy to use, reusable, set of component modules that provide a wide variety of application functions and e-commerce services. Such application functions include, but are not limited to, for example, calendar functions, scheduling of an appointment functions, reserving or booking goods and/or services, such as a car rental, hotel room, or table at a restaurant, map or GPS related functions, support for online conversations, streaming live video or other media feeds, etc. In addition, e-commerce related services include displaying product and/or service offerings, displaying user account information, engaging a sales representative in an online chat session, and enabling the purchase of goods and/or services, etc. These card services or “plug-ins” are all part of an ecosystem supported by a Wrap run-time engine viewer (described in more detail below), which allows the various plug-in services to all communicate and inter-operate together. For example, a calendar plug-in could be configured to communicate with a reservation booking database plug-in, which could communicate with a chat plug-in. The communication among the various plug-in services is accomplished through a common set of APIs. As a result, the interactivity, functionality and usefulness of wrap packages 10 are significantly enhanced by such an ecosystem of connected plug-in services.

Finally, the integration capabilities of cards 14 enable the bi-directional flow of data from users browsing a wrap package 10 to other cards 14 in the same wrap package 10, to another wrap package 10, or a remote data processing system. For example, a card 14 can be integrated with the back end software system for a large online retailer, which will automatically populate the content of a card 14 with product images, user account information, prior purchase information, and a host of other user-related information. Alternatively, a card 14 can be used to capture data input from a user and provide it to a retailer's back end e-commerce software system. For example, a card 14 may display a one-click “Buy Now” function for a displayed item. When the Buy Now function is selected, previously saved user account information is automatically delivered to the back end software system of the online merchant, which then processes the information to complete the transaction.

The data entered by the user and/or the data presented via a card 14 of a wrap package 10 may thus be integrated with the back-end database, cloud computing services, web sites, etc., regardless if managed by an author and/or distributor of the wrap package or by a third party. The data processing for the purchase of goods and/or services, appointments, and/or other application functionality and e-commerce related services may, therefore, be performed either within the wrap packages 10 itself or integrated with a remote data processing resource.

The data integration capabilities of cards 14 can also be shared among other cards 14 in the same wrap package 10, with other wrap packages, with web sites, or just about any other data processing system.

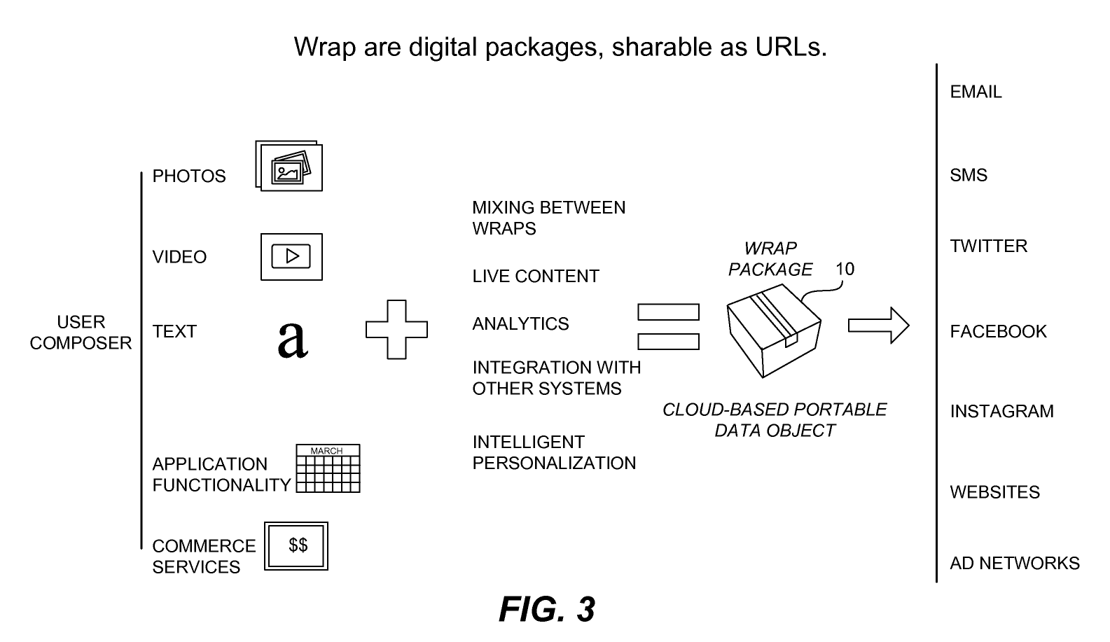

Referring to FIG. 3, a diagram summarizing the content and distribution model for wrap packages 10 is shown. As illustrated in the left most column, the content that may be included in the various cards 14 of a wrap package 10 may include photos and/or images, audio, video, text, 3-D objects, various types of streaming media (e.g., audio, video, audiovisual, data, biometric information, tickers, sensor outputs, etc.), other data types, application functionality and/or e-commerce services. This content may further be combined with content mixed from other wrap packages 10 as well as live or streaming content. The cards 14 of the wrap package 10 may be further modified based on analytics, intelligent personalization based on the demographics of targeted users or viewers, as well as the integration of either data input or data output to/from with other cards 14, other wrap packages 10, or remote data processing systems and processes, as explained above.

All of the above are then combined during the authoring process into a group of digital objects, defined herein as the wrap package 10. In non-exclusive embodiments where URLs are used as identifiers (i.e., wrap ID 42), the wrap packages are “light-weight”, meaning content of the wrap package 10 is delivered over a network to a user only when the wrap ID 42 for the wrap package 10 and/or each card 14 is identified. As a result, the media content, application functionality, and/or e-commerce related services is delivered only when needed. Also, by authoring the cards 14 using a widely supported language such as HTML, the cards 14 of wrap packages 10 can be written once and are viewable on a display associated with almost any computing device running a browser. Accordingly, unlike applications, multiple version of a wrap package 10 need not be authored for multiple platforms.

The wrap package 10 is thus essentially a cloud based portable object that may be readily distributed in a number of ways. In non-exclusive examples, wrap packages 10 may be distributed by email, SMS messaging, ad networks, Twitter, merchant/retailer web sites, photo and/or video sharing web sites that support messaging, social networking web site such as Facebook, through the down-loading of applications from aggregators such as the Apple App Store or Google Play, or just about any means for electronically distributing data over a network, currently known or developed in the future.

### Authoring and Distribution of Wrap Packages

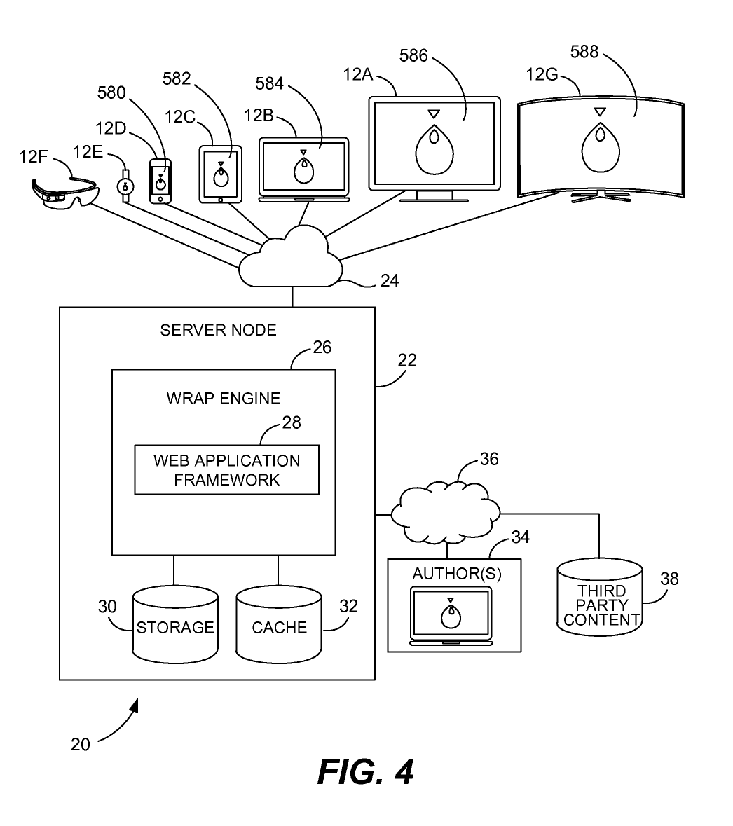

Referring to FIG. 4, a block diagram of a non-exclusive system for authoring, storing, distributing and consuming wrap packages 10 is illustrated. The system 20 includes a server node 22, a plurality of computing devices 12, including but not limited to a desktop computer 12A, a laptop computer 12B, a tablet computer 12C, a mobile “smart” phone 12D, a wearable computing device, such as a smart watch 12E or smart glasses 12F and “smart” TVs 12G. The server node 22 and the computing devices 12A-12G communicate with one another over a network 24. In various embodiments, the network 24 may be the Internet, an intranet, a wired or wireless network, a Wi-Fi network, a cellular network, other types of communication networks, or any combination thereof.

The server node 22 includes a “wrap” engine 26, which defines a web application framework 28, a storage device 30 and cache 32, each for storing wrap packages 10 and other data. The server node 22 also may include a suite of tools, such as an authoring tool (as described in detail below), an analytic engine tool, a media collaboration tool and a data transformation tool, for authoring wrap packages 10.

The web application framework 28 is a software platform designed to support the manual and/or automated authoring of wrap packages 10. The framework 28 is designed to alleviate the overhead associated with common activities performed during the authoring of many wrap packages 10. For example, the framework 28 may include one or more libraries to help with the authoring of common tasks, and modularizes and promotes the reuse of code designed to perform specific tasks, such as implementing application functionality and/or supporting e-commerce. In various embodiments, the web application framework 28 may be implemented using, but is not limited to, Ruby, Rails, JavaScript, Angular-1S, and/or any other language or framework currently known or developed and used in the future.

In a non-exclusive embodiment, the web application framework 28 of the wrap engine 26 also performs content management as a way of organizing, categorizing, and structuring the media and other content resources such as text, images, documents, audio files, video files and modularized software code so that the content of wrap packages 10 can be stored, published, reused and edited with ease and flexibility. The content management function is also used to collect, manage, and publish content, storing it either as components or whole documents, while maintaining dynamic links between the components and/or cards 14 of a wrap package 10.

In yet another non-exclusive embodiment, the web application framework 28 of the wrap engine 26 is structured around multiple tiers, including but not limited to a client tier, an application tier and a database tier. The client tier refers to the browser enabled communication devices 12 that execute and display cards 14 of wrap packages 10, as well as web pages written in or another mark-up language. The database tier, which is maintained in storage 30, contains the one or more libraries of user and/or platform provided media content, software components, modules, etc. used for the authoring of wrap packages 10. The application tier contains the software that runs on the server node 22 and that retrieves and serves the appropriate wrap package 10 from storage 30 and/or cache 32 when requested by a computing device 12.

Since wrap packages 10 are essentially data objects, they can be both cached and delivered over a Content Delivery Network Interconnection (CDN), both of which can be effectively used to deliver wrap packages 10 with minimal delay. For example, commonly requested wrap packages 10 may be cached in the cache 32, which provides faster access and delivery times than storage 30. Also other caching techniques, such as pre-caching, may be used with popular wrap packages 10, to speed up delivery times. Since the amount of storage in the cache is typically limited, cached wrap packages 10 and other data may be periodically replaced by any known replacement algorithm, such as first-in, first-out or least recently used for example.

During the composing of a wrap package 10, one or more author(s) 34 may access the server node 22 over a network 36, which may be different or the same as network 24. The author(s) 36 interact with the wrap engine 26, including the web application framework 28, and the above-mentioned suite of tools for the creation, editing, optimization and storing of wrap packages 10. In yet other embodiments, the one or more author(s) 34 can also access third party content 38 for inclusion into a wrap package 10. As previously noted, wrap packages 10 can be authored manually by one or more individuals or electronically in an automated process.

For more details on cards 14 of wrap packages, see U.S. provisional application Nos. 62/062,056 and 62/062,061, both entitled “Wrapped Packages of Cards for Conveying a Narrative With Media Content, Providing Application Functionality, and Engaging Users in E-commerce”, both filed Oct. 9, 2014, and both incorporated by reference herein for all purposes.

For more details on authoring cards of wrap packages, see U.S. provisional application Nos. 62/144,139 and 62/170,438, filed Apr. 7, 2015 and Jun. 3, 2015 respectively, both entitled “Authoring Tool for the Authoring of Wrap Packages of Cards,” both of which are incorporated by reference herein for all purposes. Also see U.S. patent application Ser. Nos. 14/740,539, 14/740,533, 14/740,617 and 14/740,839, all filed Jun. 16, 2015, all entitled “Authoring Tool for the Authoring of Wrap Packages of Cards,” and all of which are incorporated by reference herein for all purposes.

Once the authoring of a wrap package 10 is complete, it is maintained in storage 30 and possibly cached in cache 32. In response to receiving an identifier, the wrap engine 26 fetches the corresponding wrap package 10 from storage 30 or the cache 32 and serves it to the requesting computing device 12 for consumption in a format customized for the viewing device.

It should be noted that the authoring and distribution diagram of FIG. 4 is merely representative and should not be construed as limiting. For example, multiple server nodes 22 for the authoring and/or distribution of wrap packages 10 may be provided at the same or different locations. In addition, multiple instantiations of a given wrap package can 10 be stored at multiple server nodes 22, typically located at different geographic locations. With this arrangement, the server node 22 that is most capable of quickly delivering a requested wrap package 10, sometimes referred to as the “publication server”, is the node 22 that will deliver the wrap package to the requesting device 12.

### The Wrap Package

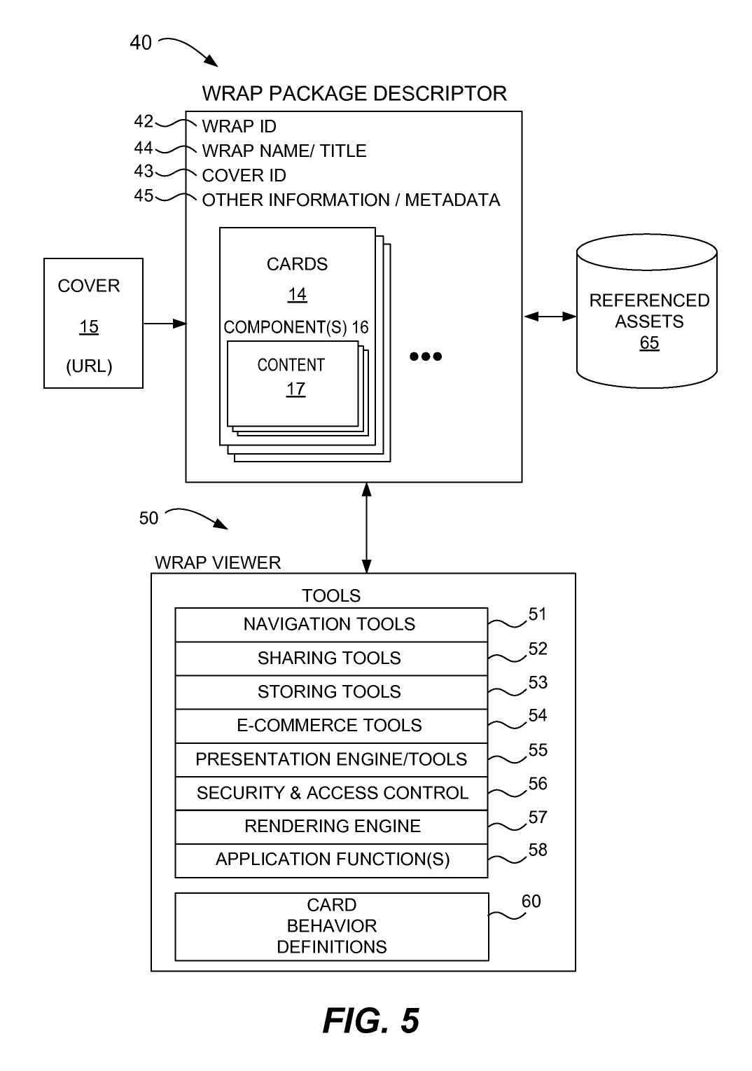

As diagrammatically illustrated in FIG. 5, a wrap package 10 includes a set of one or more cards 14. Each card 14 may contain one or more components 16 that serve as containers for content objects 17. The content objects 17, together with the behaviors associated with the cards and components 16, define the content and functionality of the cards. The content objects 17 may be simple or complex. Simple content objects 17 include standard web-based content types such as text, images, video clips, etc. More complex content objects 17 may include objects having more complicated structures and/or behaviors, as will be described in more detail below.

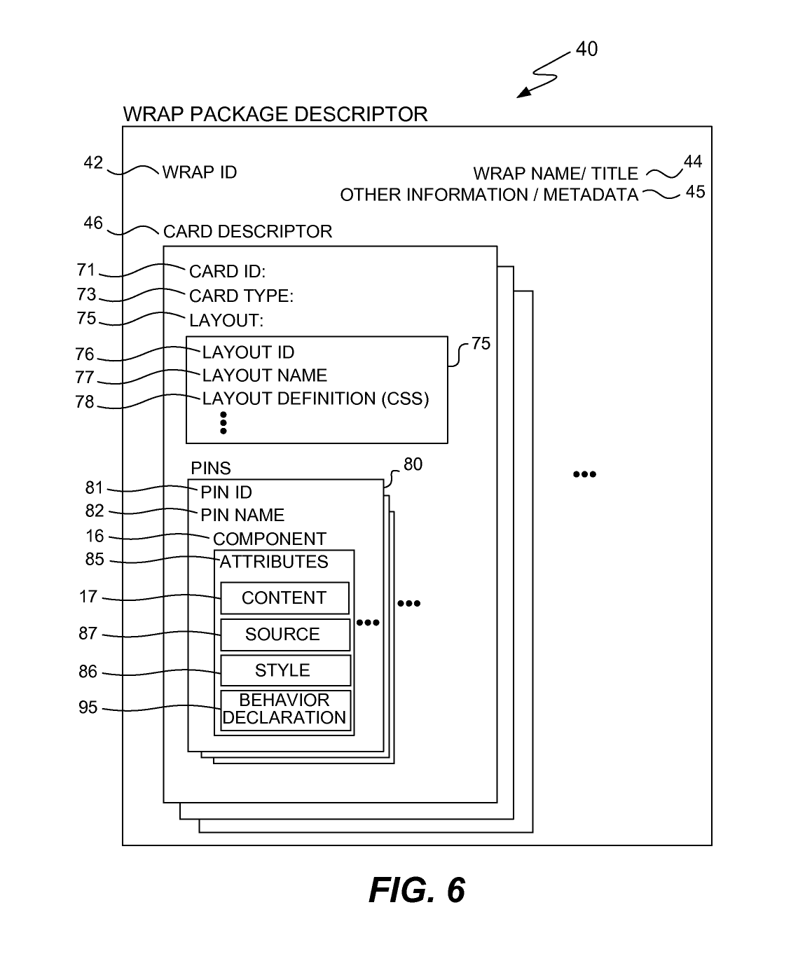

The structure of the wrap 10, including the structure, layout and components 16 of each of its cards 14 is preferably defined by a wrap descriptor 40. The actual structure of the descriptor 40 may vary widely and a few different suitable descriptor structures are described in more detail below with respect to FIG. 6. Some content objects 17, such as text, may be directly included (in-line) in the component 16. Other content objects 17, such as images or video clips, may be included by reference, e.g., through simple URL references, or in-line through an encoding method such as MIME (Multi-Purpose Internet Mail Extensions). Complex content objects 17 may be specified in-line or by reference and may (a) contain other components 16 or content objects 17 and/or (b) specify abstract behaviors.

Referenced content objects 17 stored outside of the wrap descriptor 40 are sometimes referred to herein as assets 65. The referenced assets 65 may take the form of almost any type of content that can be included in the wrap package. This can include text, photos, images, 3-D objects, audio, video, and other media content or streams and/or a variety of executable objects, services and/or other functionality. Sometimes an asset may take the form of a stream and the wrap descriptor 40 is arranged to identify the source of the stream (i.e., the feed). By way of example, the stream could be a live audio or video stream, a data feed such as a stock ticker, sensor outputs, biometric information, etc.

In certain circumstances, some or all of the assets 65 associated with a wrap 10 may be stored and accessible from a dedicated wrap server. However, that is not a requirement. Rather, an asset can be retrieved from any location that would be accessible by the consuming device (e.g., through the Internet, an intranet or private network or any other reliable means), and there is no need for the various assets 65 to be located in a single asset store, although that may be desirable in many circumstances.

The wrap package 10 has an associated identifier, the wrap ID 42, that uniquely identifies the wrap 10. The wrap ID is preferably a globally unique identifier (GUID). In some embodiments, the wrap ID 42 takes the form of a URL, or any other identifier that can be converted to, or extracted from, a URL, which facilitates access to the wrap 10 over the Internet using conventional mechanisms. An example of a conversion of the wrap ID to a URL might be adding a domain as a prefix to the wrap ID to form a URL (e.g., www.wrap.com/wrap/<wrapID>).

FIG. 5 also diagrammatically illustrates selected components associated with defining and rendering a representative wrap package 10. The illustrated components may optionally include one or more covers 15, a wrap descriptor 40, a wrap runtime viewer 50 and various referenced external assets 65. As previously noted, the wrap descriptor 40 defines the structure, layout and components 16 of each of the cards 14 within the wrap package 10. The wrap descriptor 40 typically includes the wrap ID 42 and a set, deck or array of card definitions or card descriptors 46, each defining the structure of an associated card (as described with respect to FIG. 6 for example). The wrap descriptor 40 may also include other information of interest such as a wrap name/title 44 and optionally one or more cover identifier(s) 43 and/or other information or metadata 45 about the wrap package 10.

To facilitate rendering the wrap package 10 on various different devices, the wrap is preferably stored in a data format that separates the data from the presentation. At the time of this writing, JavaScript Object Notation (JSON) is a popular, light-weight, data-interchange format that can be used to describe the wrap package 10. Thus, by way of example, the definition of the wrap package 10 may be stored as a JSON data object at the server(s) 22. That is, the descriptor 40 may take the form of a JSON object. In other embodiments, a BSON (Binary JSON) data object may be used. Although the use of JSON or BSON data objects is described, it should be appreciated that in other embodiments, the wrap package 10 may be stored in a variety of other suitable formats, whether now existing or later developed.

The optional cover 15 of the wrap package 10 is typically a graphic object that contains an embedded hyperlink to the wrap (e.g., the URL used as wrap ID 42) and can be placed in any suitable type of electronic media to represent the wrap package 10. Thus, a wrap 10 may be accessed by clicking on or otherwise selecting the cover 15 or by clicking on, or otherwise selecting any other type of link containing the wrap ID 42. As such, in order to “distribute” a wrap package 10, either the cover 15 or a link can be distributed to potential viewers of the wrap package 10 using any available tool. For example, the wrap package 10 may be distributed by: (i) placing the cover 15 or a link on a webpage, in an ad or in any other location that can be accessed by a potential viewer via a browser; (ii) by posting the cover 15 or a link on a blog, a microblog, a forum, a wall etc. or any social media distribution mechanism such as Facebook, Twitter, etc.; (iii) by including the cover 15 or a link in a message such as e-mail, SMS message, a Twitter Tweet, text messages, etc.; or (iv) using any other available distribution mechanism or platform, either known now or developed in the future. Therefore, in many circumstances, it is desirable to create a cover 15 that is attractive and entices viewers to access the associated wrap package 15. In some instances, the cover 15 may take the form of an image from the wrap package 10 itself (e.g., the first card); however, that is not a requirement.

The wrap package 10 is configured to be rendered on a consuming device 12 in conjunction with a wrap runtime viewer 50, which is also sometimes referred to as the wrap run-time engine or simply the viewer. The runtime viewer 50 provides a set of tools and functionalities that are helpful for viewing and/or interacting with the wrap. In some circumstances, the viewer 50 will take the form of a dedicated, platform specific, wrap viewer application (e.g., an applet or app in the context of a mobile device), a plug-in (e.g. a browser plug-in) or other mechanism installed on the viewing device that provides the necessary functionality. In other circumstances the wrap viewer functionality may be incorporated into other types of applications. However, limiting the rendering of wraps to devices which have preinstalled wrap viewing applications/functionality would greatly reduce their portability since users are not always motivated to install such applications unless or until they see a compelling need. Therefore, as will be explained in more detail below, the delivery of a wrap packages 10 may optionally be accompanied by a run-time viewer 50 that includes a set of associated tools and functionalities suitable for use by a conventional browser to generate and/or render the runtime instance of the wrap based on the wrap descriptor 40 and to facilitate user interaction with the wrap package 10. These tools and functionality can be thought of, and are often referred to herein as a wrap toolset that is part of the wrap runtime viewer 50. By providing the wrap construction, viewing and interaction toolset in a browser executable form together with the wrap descriptor 40, the wrap package 10 can be consumed on a wide variety of different devices and operating system platforms (e.g., iOS, Android, Microsoft, etc.) without requiring the users to download and install a device and/or platform specific viewer application. This is a powerful construct for enhancing the portability and viral distribution of wrap packages among a myriad of devices and operating system platforms

In the embodiment illustrated in FIG. 5, the viewer toolset provided with the wrap viewer 50 includes navigational tools 51, sharing tools 52, storing tool 53, various e-commerce tools 54, presentation engine/tools 55, security and access control tools 56, a rendering engine 57, and application functionality tools 58. Of course, it should be appreciated that not all of these tools are required in all implementations and that in other implementations, a variety of other tools and functionalities may be provided as well. The navigational tools 51 facilitate navigation within the wrap package 10. The sharing tools 52 provide mechanisms by which a consumer of the wrap 10 may share the wrap with others, e.g., by e-mail, by SMS message, via a social media post, etc. Storing tool 53 allows a user to persistently store the wrap and/or when applicable, the wrap state, either locally or remotely. The e-commerce tools 54 may include a variety of functionalities that can help facilitate a variety of e-commerce tasks including purchasing, making reservations, etc. Application functionality tools 58 enable “app-like” functionality within the wrap package 10, such as conducting online chats, GPS functionality, etc. Presentation engine 55 controls the presentation. In some embodiments, the presentation engine 55 may be arranged to present the wrap on the consuming device at a scale and in an aspect ratio that is at least somewhat optimized for the device.

Security and access control tools 56 provide security and access control functionality, which might include encryption functionality and user authentication services. For example, in some circumstances, the publisher of a wrap may want to limit the circulation of the wrap to specific users or groups of users. A few, nonexclusive examples of such circumstances include when the wrap is created for use as: (i) an active receipt for a purchase as described in U.S. Provisional Application Nos. 62/062,056 and 62/075,172 (both incorporated by reference herein for all purposes) and (ii) a ticket for an event as described in U.S. Provisional Application No. 62/079,500; (also incorporated by referenced herein for all purposes) (iii) an item customized for a customer such as a travel itinerary; (iv) an employee manual as described in U.S. Provisional Application No. 62/114,731 (also incorporated by reference herein for all purposes); etc. Encryption services may be desirable to protect confidential information. Of course, there are a very wide variety of other circumstances where security and/or access control/permission functionality may be desired.

With certain embodiments, the viewer 50 may optionally also include a rendering engine 57 arranged to create and/or render a runtime instance of the wrap on a consuming device 12 based on the descriptor 40. In such embodiments, the rendering engine is arrange to dynamically generate the HTML (or other markup language) use by a browser or other viewing mechanism on the device 12 to render the wrap at runtime. In some implementations, the rendering engine 57 is arranged to create an object graph based on the descriptor 40 and a document object model (DOM) based on the object graph. The browser or other suitable app or application may then use the DOM to render the wrap package 10.

With yet other embodiments, the viewer 50 may also optionally have any number of card behaviors definitions 60. As will be described in more detail below, different cards can be designed to exhibit a wide variety of different behaviors. In order to simplify the card, and card template creation processes, various desired behaviors can be defined separately from the cards themselves. The behaviors are known to or accessible by the wrap viewer 50 (e.g., desired behaviors may be defined through behavior definitions 60 or may be accessible as behavior extensions 62). Thus, the descriptor for any particular card or component may simply declare the desired behavior and the viewer 50 will know how to impart such behavior to the wrap/card/component and/or how to obtain an extension that imparts such behavior.

In FIG. 5, the behavior definitions and the various tools are illustrated as separate items to facilitate their description. However, in practice, some of the illustrated tools are simply sets of associated behaviors, and therefore, the illustrated distinction between the behaviors and such tools is/are largely for emphasis.

As discussed above, the wrap package 10 may be rendered on a wide variety of different devices 12A through 12G. These devices may have a wide variety of different screen sizes, capabilities, and viewing mechanisms. When a particular device 12 requests a wrap package 10, a determination is effectively made as to whether a suitable wrap runtime viewer is already present on the requesting device. If not, a browser compatible runtime viewer 50 is provided in addition to the wrap or wrap descriptor 40. The browser compatible run-time viewer may be written in any format that is appropriate for execution by a browser. By way of example, JavaScript (JS) is a dynamic programming language that is currently popular and supported by most general purpose browsers and many other rendering mechanisms. Thus, JavaScript works well for the browser compatible viewer since the same wrap viewer can be used for a wide variety of different browsers. However, it should be apparent that in other embodiments, the wrap viewer 50 may be implemented using a wide variety of other now existing or future developed frameworks and/or languages. For example, the DOM rendering may be replaced with a React framework or another suitable framework currently known or developed in the future. When the wrap viewer is incorporated into a native application, it will sometimes be desirable to write the viewer (or portions of the viewer) in a format that executes more efficiently or is otherwise preferred for execution on the underlying operating system, etc.

### Wrap Descriptors

Referring next to FIG. 6, a variety of specific descriptor structures suitable for use in defining various wraps, cards and/or components will be described. Although specific descriptor structures are illustrated, it should be appreciated that the structure of the various descriptors can be widely varied. In general, the descriptors are arranged to define the structure, layout, content and behaviors of the wrap without details of its presentation on a particular device. That is, the descriptors capture the functional and behavioral intent of the author, in a platform independent way, such that the runtime may implement the described structures and behaviors in a way optimal for the platform in question.

A wrap generally will include multiple cards and the corresponding wrap descriptor will typically have discrete descriptors for each of the cards. The card descriptors each include a unique card identifier and define the structure, behavior, layout and content of the corresponding card. Behaviors associated with any particular card can be applied at the card level (i.e., associated with the card as a whole), at a component level (i.e., associated to a particular component alone—which may or may not include subcomponents) or at any subcomponent level. Since the card descriptors are discrete, self-contained, units with a unique identifier, it is very easy to mix wraps (i.e., use cards created for one wrap in a second wrap). When cards are mixed, their components and associated behaviors remain the same—although it is possible to define behaviors that are context or state aware and therefore exhibit different states/properties/responses/etc. in different circumstances.

The components are encapsulated units that may have defined content (although such content may be dynamic) and, when desired, specific defined behaviors, styles and/or other attributes. In some preferred embodiments, each component has a unique identifier and may optionally also have an associated type and/or name. The use of encapsulated components with unique component identifiers makes the components highly modular such that an authoring tool can readily use and reuse the same components in different cards and/or wraps. Behaviors can be associated with the component and any component can be composed of one or more subcomponents which themselves are fully defined components.

Regardless of the level to which they are applied (i.e., wrap level, card level, component level, subcomponent level, etc.), the behaviors are preferably declared in the descriptor rather than being explicitly defined within the descriptor. In that way, the behavior declaration acts as a hook which can be used to associate virtually any programmable logic with a card/component/etc. The behaviors are preferably defined (or at least obtainable) by the runtime viewer.

FIG. 6, diagrammatically illustrates the structure of a first representative wrap descriptor 40. In the illustrated embodiment, the wrap descriptor 40 includes the wrap ID 42, the wrap title 44, and a card descriptor 46 for each of the cards 14. Each card descriptor 46 describes of the structure, layout and content of the associated card. The wrap descriptor 40 may also optionally include cover identifier(s) 43 and/or any other desired information or metadata 45 relevant to the wrap. The cover identifier(s) 43 identify any cover(s) 15 associated with the wrap. Other information and metadata 45 may include any other information that is deemed relevant to the wrap, as for example, an indication of the creation date and/or version number of the wrap, attributions to the author(s) or publisher(s) of the wrap, etc.

The card descriptors 46 may be arranged in an array, deck, or in any other suitable format. In the diagrammatically illustrated embodiment, each card descriptor 46 includes: a unique card identifier (card ID 71); a card layout 75; and optionally, an associated card type 73. The card layout 75 preferably includes at least one of a layout identifier (layout ID 76) and a layout definition 78 and optionally, a layout name 77. When the layout definition is not explicitly provided in the card descriptor 46, it may be obtained by reference through the layout ID 76. The layout definition 78 may be provided in a variety of different format. By way of example, Cascading Style Sheets (CSS) works well. As will be appreciated by those familiar with the art, CSS is a style sheet language used for describing the look and formatting of a document. Of course, in alternative embodiments, other style sheets and/or other now existing or future developed constructs may be used to define the layout of the cards.

The card ID 71 is preferably a unique identifier that uniquely identifies the associated card 14. An advantage of using unique identifiers as card IDs 71 is that the cards 14 are not wed to a particular wrap package 10, but rather, can to be used in or shared among a plurality of wrap packages. That is, once a card is created it can be used in any number of different wraps by simply placing that card's descriptor 46 at the appropriate locations in the card decks of the desired wrap package. Thus, the unique card IDs 71 can be used to help streamline the process of using one or more cards 14 from one wrap package 10 in a second wrap (sometimes referred to as the “mixing” of cards 14 and/or wrap packages 10), which can help simplify the process of creating the second wrap package. In some implementations, the card IDs 71 may also take the form of URLs, although this is not a requirement. A potential advantage of using URLs as the card IDs 71 is that the URLs can potentially be used to allow a card in the middle of the wrap to be more directly accessed from outside of the wrap.

The card layout 75 defines the layout of the components 16 of the associated card 14. Preferably the card layout 75 includes a card layout ID 76 which uniquely identifies the associated layout. In some embodiments, the descriptor itself defines the layout using a conventional web presentation definition mechanism such as Cascading Style Sheets (CSS). In other embodiments, the layout definition may be accessed from a server using the layout ID 76. As will be familiar to those skilled in the art, CSS is a style sheet language used for describing the look and formatting of a document written in a markup language. CSS enables separation of document content from the document presentation, including elements such as the layout, colors and fonts. Thus, CSS is very well adapted for inclusion within the wrap descriptor 40 itself.

It should be noted that the layout ID 76 is also useful in the context of the aforementioned authoring tool used to create and author wrap packages 10. Specifically, in some embodiments, the authoring tool is provided with a number of pre-defined templates (card layouts) from which an author of a new card can choose. Each template has one or more containers/components 16, which are arranged on the card in a predetermined manner for holding card content 17. The template itself can have any particular layout, or can be used to create a particular layout. In either case, the particular layout can be assigned a unique layout ID 76, and thereafter, be used and reused in conjunction with different cards thereby simplifying the card creation process.

The card type 73 (which is optional in the descriptor) relates primarily to such an authoring tool. For convenience, the templates may be categorized into different groups or classes. By way of example, the classes/groups may relate to their intended uses, the entity for which the templates are to be used, to the creator of the templates or any other logical grouping of templates. For example, card type 73, can be assigned to one or more predefined card templates, depending on their intended function. For instance, an authoring tool may include one or more card templates, each centric for the display of text, visual media such as photos or images, the playing of video, live or streaming media, application functionality (e.g., scheduling appointments, GPS, etc.), or supporting e-commerce (e.g., displaying products and/or services for purchases, chatting with online sales representative, etc.) respectively. Thus for each template type and class/grouping, card type ID 73 may be assigned.

With the template-based approach, the author(s) of a wrap package 10 can easily select a desired template/card layout that meets their need from a set of available templates and create a new card by readily inserting the desired content, functionality and/or services into the predefined containers. Such a template based approach can greatly simplify the authoring of cards 14 and wrap packages 10, since the author(s) need not be an expert in HTML, scripting or other typical web page language constructs required in order to create the card(s) 14 as typically required with creating conventional web pages. Rather, those details are embodied in the selected template itself, which translates to a specific layout 75, which in turn is identified by the layout ID 76. When a run-time instance of the wrap package 10 is created, layout 75 is used to format the associated card 14.

The associations between components 16 and their contained content objects 17, whether explicit in the card descriptors, or implicit and anonymous, are sometimes referred to herein as “pins” 80. When explicit, pins 80 are identified in the card descriptors 46 by a universally unique Pin ID 81, and by a symbolic pin name 82. When implicit, pins are anonymous at runtime, but may at design time be instantiated in order to provide operable constructs to the authoring tools, in which case they will share the name and ID of the component they bind and associate.

Whether implicit or explicit, these conditions are equivalent, and one representation may be trivially transformed into the other and vice versa, with no loss of meaning. The runtime, authoring environment and other tools are free to transform the object graph as they see fit, and whether the association is treated as intrinsic or extrinsic is irrelevant for the purposes of the determination of the structure of the wrap and its contents, this transformation being a matter of convenience.

The symbolic name of a pin (pin name 82) or component is both Human and Machine-Readable, for example, “Headline”, “Glyph”, “Body”, “Image”, “Video”, “Cul-de-sac”, or any other heading that the template designer deems appropriate. The symbolic name is used to identify its function; can be used and bound to by constraints and layouts to further constrain their display, behavior and function; and is used by the authoring tools to identify the role of the thus-associated component and map fields from one layout to another when changing the layout associated with a card. Multiple pins or components can share the same symbolic name. When they do, it implies that they serve the same role in the system, and that the same rules will apply to them.

Components 16 contain there associated content 17 and may also contain or reference zero or more attributes or constraint objects, specifying metadata to manage or modify the display of, or behavior of, that component. Constraint objects may specify abstract symbolic data used by the runtime to determine how to display or manage the object containing it, (the Constrained Object,) or the behavior of that object. Examples of such abstract symbolic data are CSS class names, behavior names, or other symbolic names acted on by other objects in the system. Constraints may also contain concrete specifications to modify the display or behavior of the object, or its container or any contained objects. An example of the former is containing CSS rules applied to the content. An example of the latter is inclusion inline or by reference of JavaScript code that acts on the constrained object.

The various constraint objects may be thought of as attributes that define the style, format, behaviors, source/feed, and/or constraints associated the corresponding content 17. In the illustrated embodiment, these attributes include style attributes 86, source attributes 87 and other constraint objects such as behaviors 60, 62. Of course, other attributes of a component can be defined and declared as appropriate for the associated content.

The style attributes associate various styles with the content 17 and may take the form of style sheets (e.g. CSS) or other conventional style definition mechanisms. By way of example, if the content 17 is a text string, the style attributes 86 may include features such as the font, size, case, color, justification, etc. of the text. If the content is a glyph, the style attributes may include the color of the glyph, the size, etc. The source attributes 87 indicate the source of the associated content 17. In some circumstances, the source attribute may simply be a reference or pointer (e.g. a URL) that identifies the location of a static content object (e.g., an image, a photo, a video, etc.).

### Creation and Distribution of Wrap Packages

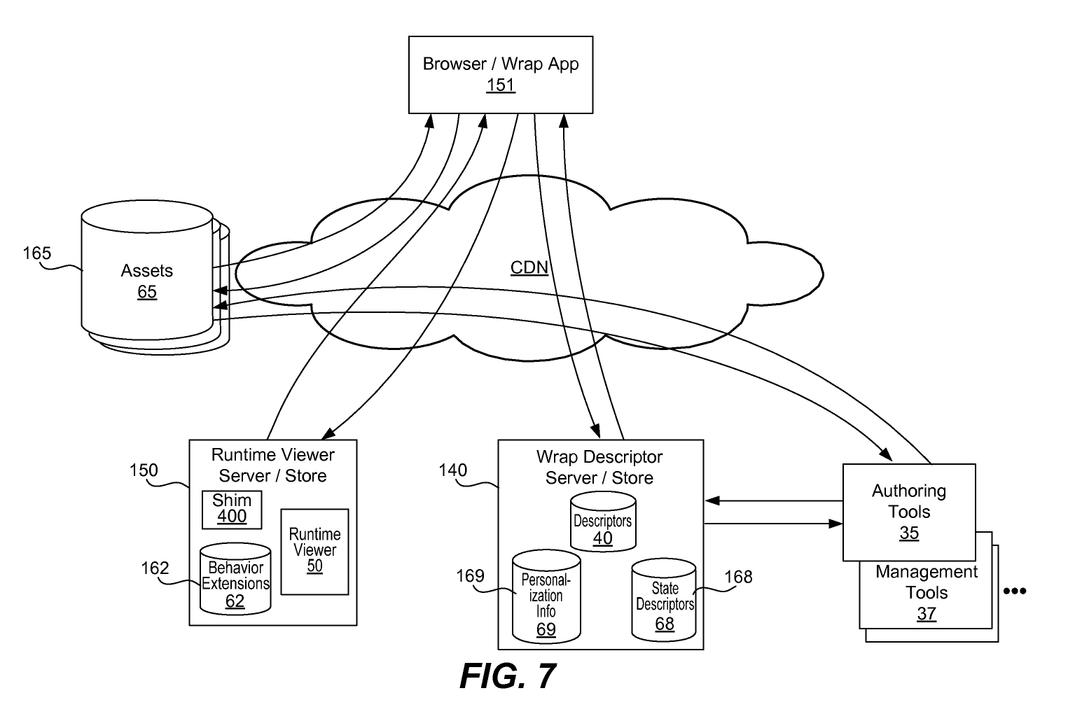

Referring next to FIG. 7, another embodiment of an environment for the creation and distribution of wrap packages will be described. The environment includes one or more of each of wrap descriptor server/store 140, runtime viewer server/store 150 and asset stores 165. A browser 151 or runtime viewer app running on a communication device 12 communicates with the server/stores through an appropriate network (e.g., the Internet), which is preferably configured as a content delivery network CDN. The runtime viewer server/store 150 is arranged to store and deliver the runtime viewer 50, extensions 62 and/or a shim 400 (described later) upon request. That is, requests for the runtime viewer 50, extensions 62 and shim 400 are directed towards and fulfilled by the runtime viewer server/store in the illustrated embodiment.

The wrap descriptor server/store 140 is arranged to store and deliver upon request the wrap descriptors 40, state descriptors 68 and any other personalization information 69 relevant to a particular user. Thus, requests for specific wrap descriptors 40, state descriptors 68 and any other personalization information 69 are directed towards and fulfilled by the wrap descriptor server/store 140. The state descriptor store(s) 168 and personalization store(s) 169 may be contained within the wrap descriptor server/store 140. When desired, multiple different wrap descriptors server/stores 140 may be used and/or the state descriptors 68 and/or personalization information 69 can be stored and delivered from other locations.

As previously mentioned, the assets 65 may be stored at a wide variety of different locations as diagrammatically represented by asset stores 165. Wrap authoring tools 35, management tools 37 etc. can also communicate with wrap descriptor server/store 140 and asset stores 165 as appropriate. The authoring tools may access existing wrap descriptors 40 to facilitate new wrap creation, wrap mixing and/or wrap editing (when permitted). The authoring tools would also access the wrap descriptor server/store 140 to upload new wrap descriptors, etc. Similarly, assets stores 65 may be accessed and/or added to as part of the wrap creation process. Similarly various management tools 37 may be arranged to communicate with the various stores to facilitate any desired management, tracking and other functionality.

### Request Wrap Package and Render on Device

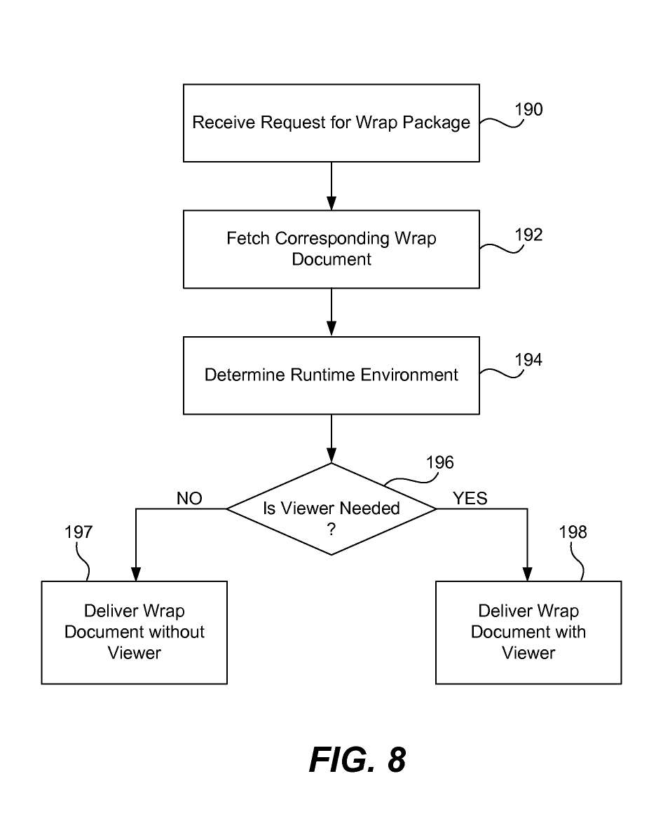

Referring to FIG. 8, a representative process suitable for delivering wrap packages is described. In the illustrated embodiment, a server (e.g., publication server node 22 or runtime viewer server/store 150) initially receives a request for a particular wrap package 10 (step 190). In embodiments in which the wrap ID 42 is a URL, the request can be invoked at a requesting device 12 simply by activating (e.g., clicking on or otherwise selecting) a link that contains or otherwise defines the URL. Thus, the wrap 10 can be accessed from virtually any platform capable of accessing a web link. As previously discussed, a cover that represents the wrap may include the wrap ID URL and thus the request can be invoked by simply clicking on a cover which may be embedded in a web page or an ad served in conjunction with a web page, embedded in a messages, such as an email, a text or SMS message, embedded in a Twitter tweet, or may be included with any other delivery mechanism that supports the embedding of a link.

When the server receives the request it identifies and fetches the desired wrap package 10 based on the wrap ID 42, contained in the target URL (step 192). The server also determines the run-time environment on the requesting device (step 194). This can be accomplished using standard bootstrap queries to the requesting device 12. The determination of the run-time environment will typically include an identification of the type or class of the requesting device 12 and viewing software, such as the operating system of the device 12 and/or a particular browser that the device 12 may be using. For example, the determination would typically ascertain the particular model of the requesting device (e.g., an Apple iPhone 6 Plus, a Samsung Galaxy S4, or other particular smart phone, tablet, laptop computer, desktop computer, smart watch, etc.) and the version of the software (e.g., browser or app) that is making the request, etc., and whether or not the requesting device has an installed wrap viewer or not. Of course, the server can also ask the requesting device for any additional information considered useful.

A determination is also made regarding whether a runtime viewer is already present on the requesting device (step 196). If a suitable viewer is present on the requesting device (e.g., the device has a wrap viewer app installed thereon or a browser based viewer is already present on the device), the requested wrap is delivered without a viewer in step 197. Alternatively, if a viewer is not present on the device, an appropriate run-time viewer 50 is delivered together with the requested wrap in step 198.

The delivered wrap package 10 is opened and consumed by the user on the device 12 via either a browser operating in cooperation with a wrap viewer 50 or the wrap package app. In either case, the layout of the cards 14 is customized for display on the screen of the requesting device 12. Once opened, the user can view, experience and interact with the wrap package 10 as intended by the author.

Regardless of whether the wrap viewer 50 is already present on the requesting device or is supplied together with the wrap 10, the presentation tools 55 are responsible for rendering the wrap 10 in a format suitable for the requesting device. Thus, when the wrap 10 is rendered, all of the content of the card(s) 14 is preferably arranged to fit on the display screen without the user needing to manually size the screen or scroll through the card, unless the card is specifically designed for scrolling such as may be the case with a gallery type card. This can be done because the presentation tool 50 knows the screen dimensions for the rendering device 12 and selects the presentation that is optimized for the particular display on the requesting device 12.

In a nonexclusive embodiment, the browser based versions of the run-time wrap viewer 50 may be written in a widely accepted format that can be executed by general purpose browsers operating on most any device. By way of example, JavaScript currently works well for this purpose, although other frameworks may be used as well. In some embodiments, the viewer 50 is a general purpose viewer that includes many, most, or all of the viewer tools and behavior definitions 60 that are available in the wrap ecosystem so that virtually any wrap can be viewed and all of its featured implemented using the accompanying viewer. In other embodiments, it may be desirable to provide a more compact viewer that includes a basic set of viewer tools and behavior definitions that is suitable for rendering and interacting with most wraps, or a basic set accompanied by any additional tools/behavior definitions that deemed necessary to render and/or interact with the specific wrap delivered.

It is anticipated that as the popularity of wrap packages increases, more users will install wrap viewers on their devices in the form of mobile apps, applications, browser plug-ins, etc., which is expected to reduce the proportion of wrap requests that require run-time delivery of a browser based viewer.

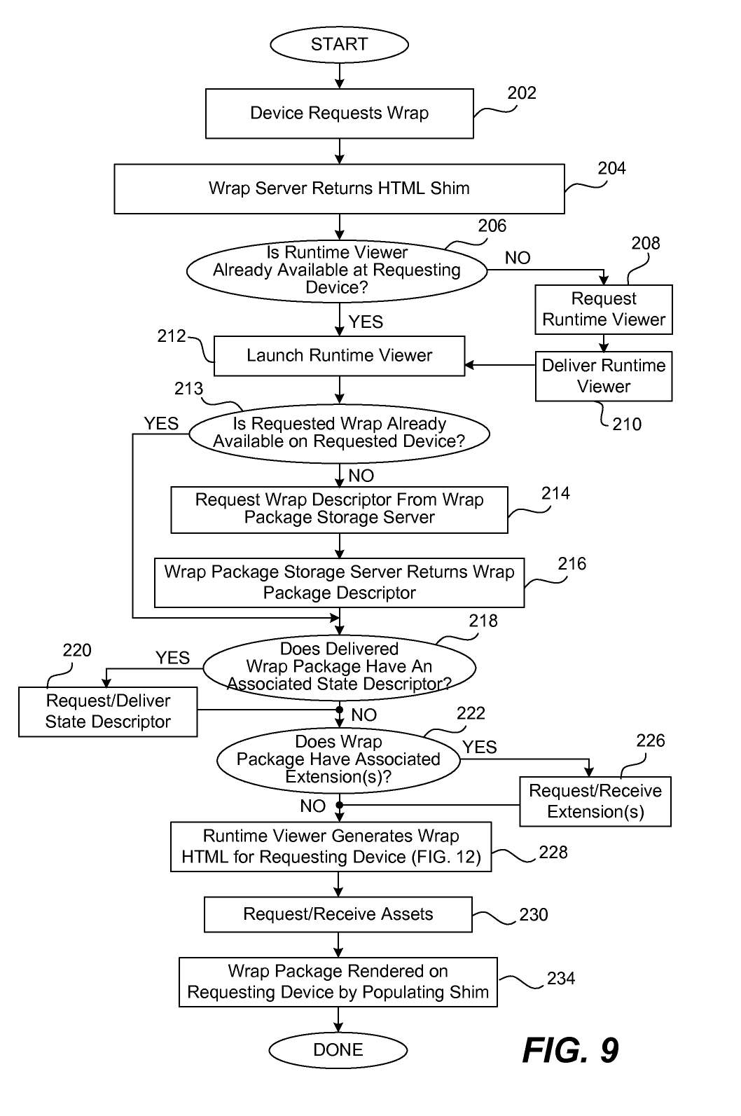

Referring next to FIG. 9, an alternative, browser based process for requesting, delivering and rendering wrap packages will be described. This embodiment is well suited for use with the multi-tier wrap engine architecture of FIG. 7. In this embodiment, the runtime instance of the wrap package is constructed locally at the requesting device based on the wrap descriptor at runtime. Such an approach may have several potential efficiency related advantages over the process described with respect to FIG. 8 including supporting simpler wrap caching strategies.

Initially, in step 202, a browser 151 on a requesting device 12 requests a particular wrap package 10 using the wrap ID 42. As previously described, in embodiments where the wrap ID 42 is a URL, the request can be invoked at a requesting device 12 simply by activating (e.g., clicking on or otherwise selecting) a link that contains or otherwise defines the URL. Thus, the wrap 10 can be accessed from virtually any platform capable of accessing a link. In the embodiment of FIG. 7, this request is directed to the runtime viewer server/store 150, although in other embodiments, the same function can be performed by wrap server node 22.

When the runtime viewer server/store 150 (wrap server node) receives the request, it returns a generic HTML shim to the requesting device 12 (step 204) rather than directly returning the requested wrap at this stage. The shim opens into a page (e.g., a blank browser Web page) that will be populated with the wrap and includes scripts suitable for initiating the process of accessing and rendering the requested wrap package 10. The primary function of the shim is to provide a mechanism for calling the runtime viewer 50. This is accomplished by a script tag. Thus, the shim ensures that the requesting device has, or obtains a runtime viewer suitable for handling the wrap before the wrap is actually delivered.

The shim may be implemented in HTML code that is delivered to a browser in step 204 in response to a wrap request 202 and is highly compact. It includes a script tag, a default page title, a style sheet that defines the initial layout of the page that will hold the wrap, an icon image, and a div. The script tag is primarily responsible for requesting the runtime viewer 50. The default page title is the label that is typically displayed in the browser tab associated with the blank window page into which the wrap is opened. The style sheet defines the layout of the page that is initially displayed, which is essentially blank at the initial stage. In this example, CSS is used to define the page layout, although any other layout definition that can be interpreted by the browser can be used. The icon image is an image that some browsers display in the browser tab adjacent the title. The div causes the browser to allow the runtime viewer to rewrite the DOM for the page starting from that defined div node.

Returning to FIG. 9, the browser that receives the shim will typically handle the runtime viewer request by first checking to see whether an appropriate runtime viewer 50 is already present on the device (step 206). If so, the runtime viewer 50 is launched in step 212. If a suitable runtime viewer is not already present on the requesting device, a suitable viewer is requested and delivered to the requesting device (steps 208/210) and launched by the browser (step 212). In the embodiment of FIG. 7, the runtime viewer request is also directed to runtime viewer server/store 150.

The downloaded runtime viewer may be written in a format that can be executed by most browsers so that the same generic runtime viewer may be used to view any wrap on virtually any computing device that contains a general purpose browser. By way of example, JavaScript is a dynamic programming language that is currently well supported by most browsers, and is therefore, well suited for use in the runtime viewer. Of course, other now existing of later developed programming languages and frameworks may be used in other embodiments.

Once the runtime viewer 50 launches, it requests the wrap based on the wrap ID 42 used in the initial request. In a non-exclusive embodiment, the request may take the form of WRAPI.WRAP.CO/WRAP/<WrapID>, where <WrapID> is the wrap ID 42. In response, the browser or viewer will typically check to see whether the wrap descriptor 40 corresponding to the wrap ID 42 is available locally (step 213). If not, the wrap descriptor 40 is requested from and returned by the wrap descriptor store 140, as represented by steps 214, 216.

In embodiments where the initial wrap request comes from an executing runtime viewer (as for example from a native viewer app), then there would be no need for steps 204-212 and the initial wrap request 202 would initially check for the requested wrap descriptor locally (step 213) and proceed from there.

Once the wrap descriptor 40 is received, it is processed by the runtime viewer 50 resulting in the construction and rendering of the wrap in the browser page associated with shim 400. Some of the steps performed or caused by the runtime viewer 50 as it processes the wrap descriptor 40 are schematically represented as elements 218-234 in the flow chart of FIG. 9. Although a particular flow is illustrated, it should be appreciated that the described steps are functional in nature and are not necessarily performed in the illustrated order.

While processing the wrap descriptor 42, the runtime viewer 50 determines whether the wrap package 10 has an associated state descriptor 68. As discussed above, it is contemplated that many wrap packages will not have an associated state descriptor while others will. A number of mechanisms can be used to indicate the intended/expected presence of a state descriptor 68. By way of example, in some embodiments, the wrap descriptor 42 includes a state descriptor flag (not shown) that indicates whether a state descriptor 68 is intended to be associated with the wrap. In such embodiments, the runtime viewer 50 determines whether to request the state descriptor 68 based on the status of the state descriptor flag. In another example, wraps 10 that require state descriptors 68 may be arranged to simple declare the existence of an associated state descriptor and the runtime viewer may be arranged to request the appropriate state descriptor. If a state descriptor 68 is intended, it is requested and received as diagrammatically represented by step 220. In the embodiment of FIG. 7, any state descriptor requests are directed to wrap descriptor server/store 140, although they may be directed to wrap server 22 or other suitable stores in other embodiments. Typically, the browser or runtime viewer would first check to see if the state descriptor is cached or stored locally before sending a request to the server.

Another step performed by the runtime viewer 50 is determining if the wrap 10 has any associated behavior extensions 68. As discussed above, the wrap 10 may have a number of associated behaviors. The runtime viewer 50 may internally support many, most or all such behaviors. However, to help keep the runtime viewer 50 relatively compact while supporting a wide variety of functionality, the runtime viewer 50 is configured to support additional extensions 62 that may be utilized to define additional behaviors. Thus in step 222, the runtime viewer 50 determines whether any extensions 62 are needed to properly render the current wrap (step 228). If yes, the needed extensions are requested and retrieved (step 226). There are a number of mechanisms that can be used to trigger the extension request(s). For example, the wrap descriptor 40 may be arranged to identify the needed extensions 62 such that they can be retrieved as a group early in the wrap rendering process. In other embodiments, the extensions 62 may be retrieved on an as needed basis as the descriptor 42 is processed or in any other suitable manner. In still other embodiments, the required extensions 62 (which may be written in JavaScript or other suitable form) may be included as part of the descriptor 42 itself—as for example, in a block after the card descriptors or at the end of the descriptor. In such circumstances there would be no need to separately request the extensions. Regardless of the embodiment used to retrieve the extensions 62, or if no extensions 62 are needed, the runtime viewer 50 generates the HTML for the requesting device 12 in step 228. In the embodiment of FIG. 7, any extension requests are directed to the runtime viewer server/store 150.

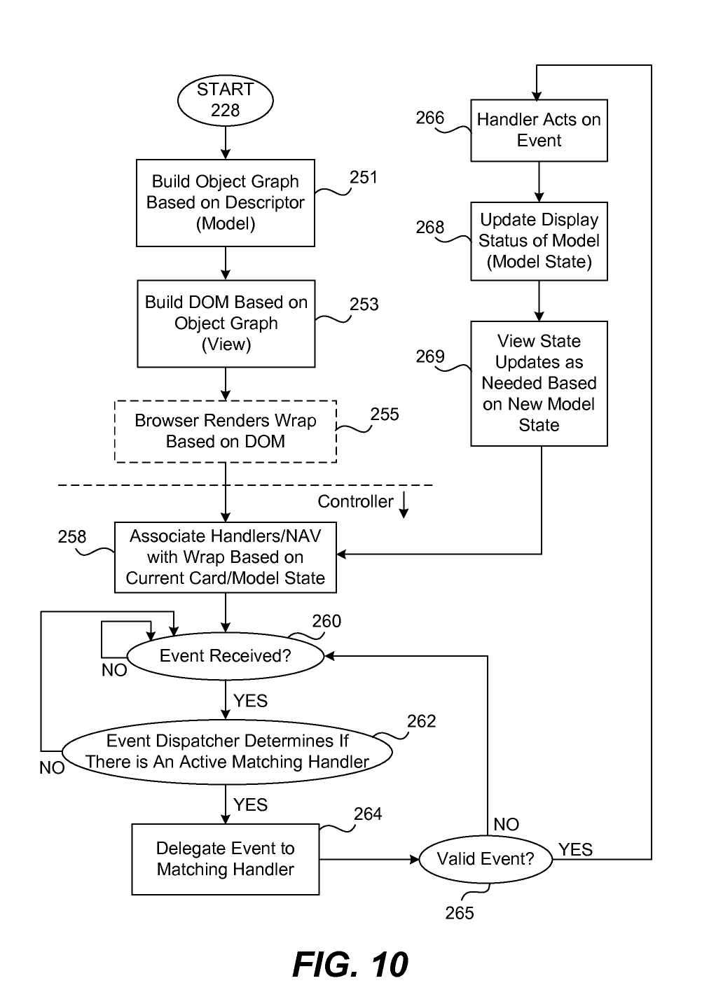

The runtime viewer is arranged to process the wrap descriptor 40 in a manner that generates the HTML appropriate for rendering the wrap on the requesting device (Step 228). This processing is described in more detail below with respect to FIG. 10.

As part of the processing and rendering, the assets 65 associated with the various cards 14 associated with the wrap 10 are retrieved in step 230. In many cases, the assets 65 associated with a particular card will be retrieved as their associated card descriptors are processed during the wrap descriptor processing. However, it should be appreciated that the actual timing of the asset requests may be widely varied. For example, in some circumstances it may be desirable to only download certain assets 65 when the associated card is displayed or just prior to the card being displayed, in accordance within some predetermined caching strategy. In some embodiments, the runtime viewer 50 determines the timing of the asset requests, while in other embodiments, such decisions may be delegated to the browser. As previously discussed, the assets may be stored at a variety of different locations as diagrammatically illustrated as asset stores 165 in the embodiment of FIG. 7.

As the wrap descriptor is processed, the wrap is rendered on the requesting device by populating the tab or page opened by the shim (step 234).

In some circumstances the initial wrap request may come from a runtime viewer that is already open and executing. In such circumstances it may be desirable for the runtime viewer to directly request any needed wrap descriptors from the wrap descriptor storage server (e.g., wrap descriptor store 1040). Such a process would effectively skip described steps 202-212.

### Rendering Wrap Packages

Wrap packages are each an abstract, platform-independent data structure containing all the information needed for a wrap runtime engine 50 to render the wrap and facilitate its interaction and behaviors. Although a non-exclusive implementation of the wrap runtime is in the Javascript programming language for execution within a conventional web browser using HTML and CSS, the wrap runtime could also be implemented using other languages and technologies specific to different operating systems and devices. Since the runtime engine 50 renders the wrap at the time of consumption, it can optimize the rendering and interface for the device it is running on as well as dynamically generate content based on context.

Referring next to FIG. 10, a process of generating and updating the view of the wrap 10 during rendering is described. Initially, in step 251, the runtime viewer 50 generates an object graph based on the descriptor 40. The object graph serves as the state model for the wrap. In the illustrated embodiment, the wrap descriptor 40 uses the JSON data format. In general, the object graph is arranged to represent the structure of the wrap document in a manner that: (1) is simpler to transform for presentation; and (2) that makes the behaviors and styling information readily available for the runtime to apply as needed. The object graph can be created using a variety of techniques. As will be appreciated by those familiar with the art, using JSON objects as the wrap descriptors makes runtime generation of the object graph a relatively simple and straightforward task. The JSON object is transformed into JavaScript objects automatically by the runtime. Then straight-forward transformations take place to transform the on-disk representation into a runtime object graph from which it is easier to render the desired views and attach the desired behaviors.

After the object graph has been built, the runtime viewer creates a document object model (DOM) based on the object graph (step 253). The DOM corresponds to the view, and as will be appreciated by those familiar with the art, the DOM is a standard representation that may be used directly by the browser to render the wrap in a conventional manner (step 255). That is, the DOM is an internal representation that can be directly used by the browser to render the wrap.

Once the DOM has been built, the runtime viewer associates the appropriate handlers and navigation tools based on the current model state (step 258). That is, if the first card is displayed, the viewer will associate the event handlers and navigation tools with the wrap that are appropriate for the first card. These include the handlers associated with triggers as previously discussed.

Thereafter, when a user input event is received from a user interacting with the wrap, the appropriate handler processes the received event. This process is diagrammatically represented by the event loop that begins at step 260.

When an event is received at 260, an event dispatcher determines whether there is an active handler that matches the event (step 262). If so, the event is delegated to the matching handler (step 264), which determines whether the event is valid (step 265). If valid, the handler acts on the event (step 266) and updates the display status of the model (i.e., the handler updates the state of the object graph model). In step 268, the view state is then updated as needed based on the new model state. Any time the view state changes, the active handlers are updated as necessary based on the new (i.e., then current) model state (step 269). Thereafter, control is returned back to step 258 and the above process is repeated if a new event is received in step 260.

Of course, there may be a wide variety of different handlers that are appropriate for specific cards and/or model states. In some circumstances the same gesture may invoke different behaviors based on the active card or model state. For example, a left swipe gesture made on the last card may invoke an animation that gives the appearance of the card beginning to flip, but then springing back, to graphically suggest that the displayed card is the last card. To facilitate this, a final card left swipe animation handler may be activated when the last card is displayed, whereas the left swipe page transition handler would be deactivated.

The handlers associated with triggers are also particularly important to the wrap environment. For example, selection of a trigger component (e.g., by tapping at any location on a screen within the bounds of a displayed trigger component) may activate the trigger. Of course a wide variety of different events can be used to activate a trigger. In many instances, the events will be user initiated events such as selection or tapping of a trigger through the performance of a selection gesture or based on some other user input. In other circumstance, the activating step may system generated (e.g. an elapsed time, a sensor input that exceeds a threshold, the receipt of a particular message or a very wide range of other potential events).

Once activated, a trigger may exhibit any desired behavior which can be associated with the trigger through appropriate behavior declarations 95. By way of example, if the trigger is a linking trigger, the trigger may initiate a navigational link to another card or wrap, or link to an external webpage once activated using a defined linking behavior (e.g., open in same tab, open in new tab, etc.) Other triggers can have a wide variety of different associated behaviors to support almost any type of application functionality.

As discussed above, the runtime viewer may be arranged to execute in a browser 151. In a nonexclusive embodiment, the runtime viewer may include a runtime engine having an object graph building module, a DOM building module, an event handler, and a behavior engine. The object graph building module is arranged to process a wrap descriptor 40 to create an object graph that serves as the runtime instance of the wrap. The DOM building module 504 uses the object graph, to create a document object model (DOM) that serves as a browser readable instance of the wrap. The event handler 506 is arranged to handle events that are received once a wrap has been rendered. The behavior engine 508 includes a library 541 of behavior definitions 60. In embodiments that support behavior extensions 62, the behavior engine 540 is also arranged to obtain behaviors extensions 62 from external stores as necessary. Such behavior extensions 62 may be arranged as a bundle or package of behaviors or as individual behavior definitions.

In a nonexclusive embodiment, the object graph 510 may include an ordered card list, a set of cards definitions and an asset load state tree. The card list represents the order of the cards and provides a simple mechanism for supporting linear navigation through the card set. The card list may use a wide variety of different formats. By way of example, a doubly linked list works well in many applications.

The card definition includes a card definition for each card in the wrap. The card definition includes each of the component objects of the card and associates all of the relevant assets and attributes (including styles, behaviors, etc.) with the respective components.

The asset load state tree is a data structure that identifies each asset that is referenced in the wrap descriptor and indicates whether the referenced asset has been loaded into the runtime. In some embodiments, the asset load state tree takes the form of a tree of semaphores. Each time an asset is loaded, the corresponding entry (e.g. semaphore) in the asset load state tree is changed from a “not loaded” to a “loaded” state. In this way, the runtime can quickly determine whether any given asset is already present when rendering a card.

### Automatic Sizing

The present application is directed to preserving the original impression of a wrap package of cards and of each individual card by maintaining the same aspect ratio of the original wrap package as created in the authoring tool, and displays the wrap package and its cards in the same aspect ratio across any number of devices 12A-12G, all the while preserving the original impression. In other words, even though the physical dimensions of a wrap package displayed on a particular screen may change, the aspect ratio remains the same and the impression is preserved.

Although an aspect ratio and different sizes of cards based upon that aspect ratio may be determined in a variety of manners, in one embodiment, a viewport size audit was conducted of common devices (e.g., mobile phones, tablets, laptops), of browsers on laptop computers, and of browsers contained within popular social and browsing applications. Based upon this empirical data, a particular original size and aspect ratio was chosen that can fit within most all of those viewports either in its original size or by scaling up and down.

In one very specific, but non-exclusive, example that will be used below to illustrate the present invention, a wrap package is created in the authoring tool having portrait-style dimensions of 640×910 pixels, providing a particular aspect ratio which elegantly scales up and down across a wide variety of devices. This aspect ration was chosen as its fills most of the screen on a larger number of devices. This particular portrait-style aspect ratio is especially well-suited for the presentation of wrap packages and their cards on mobile phones, as well as on tablet computers, laptop computers and desktop computers. This “tall” aspect ratio is generally used to help the user focus on details in the screen. The below discussion describes how the impression intended by a particular card is preserved, regardless of whether the wrap package having these dimensions is resized in order to properly display it on different mobile phones and other computing devices.

Of course, a wrap package may be created in many other dimensions (and aspect ratios), and these other wrap packages having other aspect ratios may also be resized in order to preserve not only their aspect ratio but also the original impression using the present invention. For example, a wrap package may be created in the authoring tool having landscape-style dimensions of 1920×1280 pixels, providing a wider aspect ratio. This particular “wide” aspect ratio provides an immersive experience, and is especially well-suited for the presentation of wrap packages on much larger screens such as televisions and movie theater screens. A wrap package may also be created having dimensions of 1920×1280 pixels, providing a “far” aspect ratio that is well-suited for presenting information on billboards and other media that is viewed from much larger distances. Thus, various wrap packages may be created having dimensions of any size pixels that provide unique aspect ratios suited especially for a wide variety of display formats and/or custom applications.

A custom aspect ratio may also be created for specific purposes. For example, an aspect ratio may be created for a watch face, such as a smart watch, which is circular. Or, an aspect ratio may be created for a future computing device that becomes popular. Or, an aspect ratio may be created for a popular social media format, such as the square one finds on Instagram, should that viewport size become requested. With each viewport, the user will be able to set the relationship of the constituent components found within and that relationship will be preserved and used for those viewports.

It should be noted that all of the screen sizes, viewports, pixel dimensions, etc., for the various devices in portrait and landscape modes described in the application are merely illustrative examples and should not be construed as limiting. As future computing and viewing devices become available, they will likely have different sizes, aspect ratios, pixel dimensions, etc. Thus, the techniques and principles described herein will still be applicable, but the specific examples provided may not apply to every future device.

As discussed above, rendering engine 57 of wrap viewer 50 is responsible for rendering the wrap package on the user's computing device. In certain non-exclusive embodiments, the rendering engine can also perform the automatic sizing steps described below preferably in conjunction with step 234 of FIG. 9. Note that the rendering engine performs its tasks whether the viewer is a native viewer on the user's device (i.e., already present on the user's device), or delivered together with the wrap package to the user's device. Further, the rendering engine is making use of the data, components, contents, and relationship between components established during creation of the wrap package in the authoring tool. As previously noted, the original impression of each card in the wrap package has already been established during the authoring process using the authoring tool. The rendering engine 57 is thus responsible for rendering the wrap package for the screen size of a particular device while maintaining the original aspect ratio and the original impression.

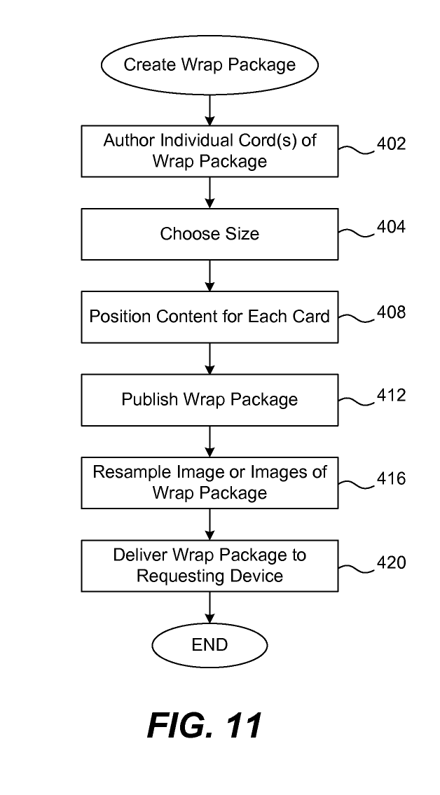

FIG. 11 is a high-level flow diagram 400 illustrating one embodiment by which a wrap package is created and delivered. In step 402, the individual card(s) of the wrap package is/are authored using the authoring tool 34, as explained in more detail in U.S. patent application Ser. No. 14/740,539 (P016A, Ser. No. 14/740,533 (P016B), Ser. No. 14/740,617 (P016C) and Ser. No. 14/740,839 (P016D), incorporated by reference herein.

In step 404, during the authoring of the wrap package, a size is chosen for the wrap package and each of its cards; for example, a relatively “tall” size such as 640×910 pixels, which defines a particular aspect ratio. Of course, any other size and/or aspect ratio may be chosen for a wrap package and its cards, such as the “wide” and the “far” sizes mentioned above, as well as custom or other sizes.

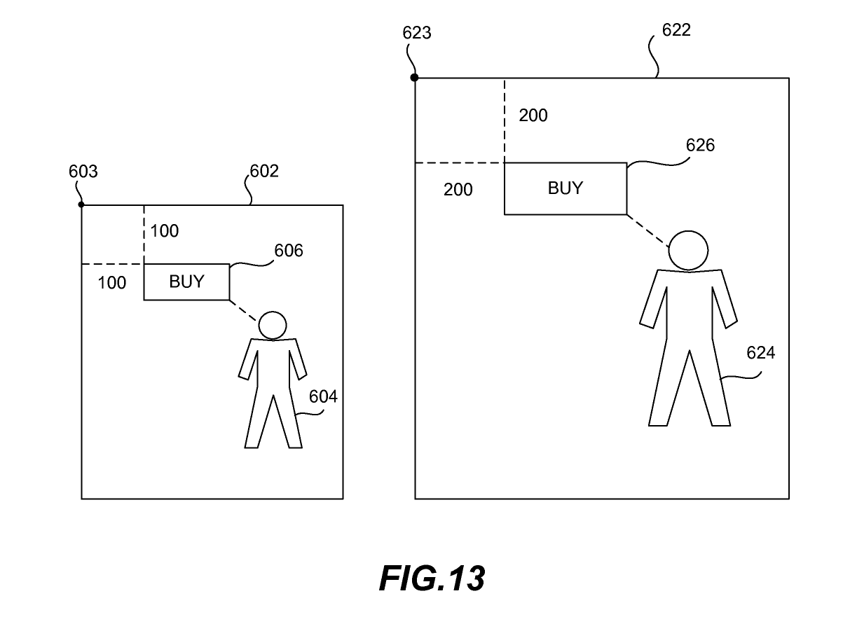

In step 408 each card of the wrap package is created to include any of a variety of content (e.g., text, images, buttons, links, etc.) and this content is positioned relative to one another within each card to create an overall impression of each card. For example, FIG. 1 shows a variety of cards, each of the same size, having different types of content positioned in various relationships. FIGS. 13, 14 and 16 also show individual cards with content in particular positions. In the embodiment in which the chosen size is 640×910 pixels, the content is placed into a grid of 640×910 pixels. Each content item contained within a card has specific coordinates within that grid. As explained with reference to FIG. 6, content items are encoded and stored as component data structures or data objects. Thus, at the time of authoring and creation, wrap packages have a defined size and a default scale factor of “1”. As explained below, both may be modified depending upon the device.

In step 412 the wrap package is published, including encoding and recording the wrap package, and storing it in a database such as a database 140. The wrap package is thus maintained at wrap store 140.

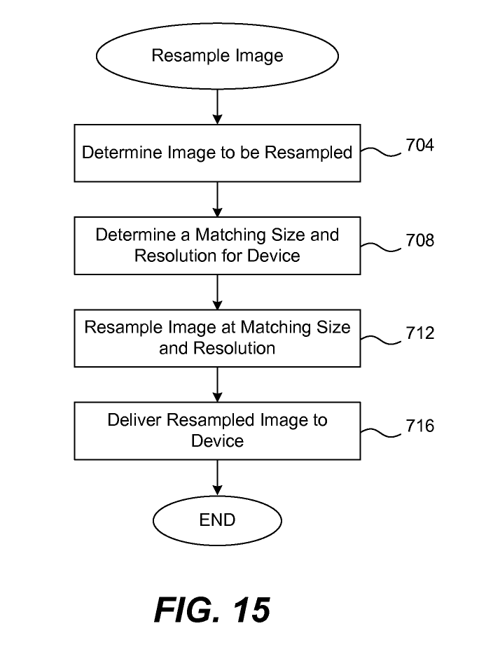

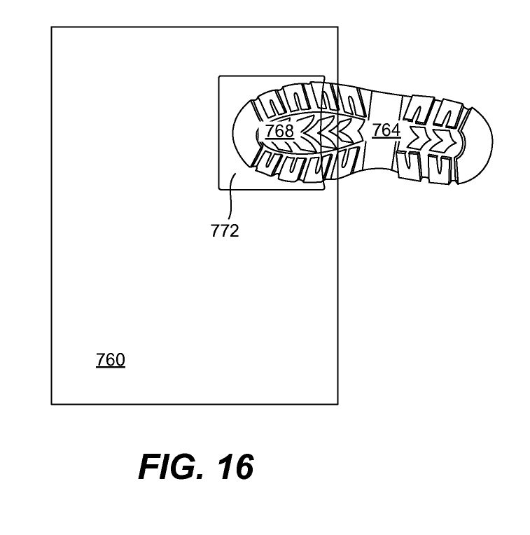

In step 416, before delivering the wrap package to the requesting device, suitable images or image portions within each card of the wrap package may be resampled by wrap server 140 (or other computer) to be the correct size and resolution for the requesting device in order to increase efficiency. This is an optional step and will be explained in greater detail below with reference to FIGS. 15 and 16.

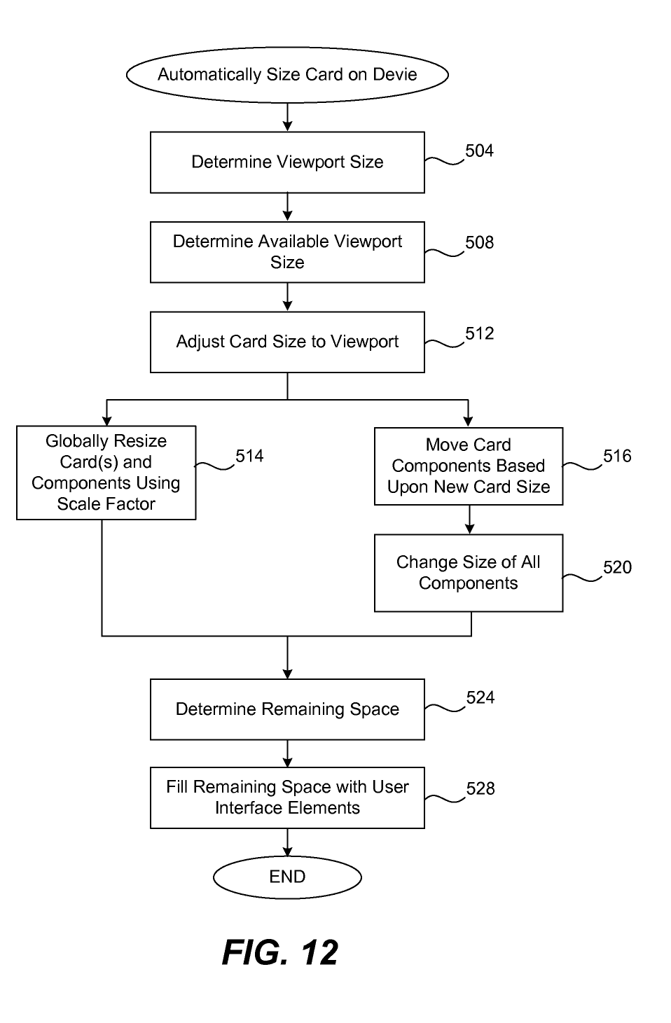

Finally, in step 420, the store 140 serves the wrap package to a client device 12 upon request. The display window of the requesting device 12 may widely vary, from very large as is the case with smart TVs or desktop computers, to very small as is the case with mobile phones and tablets. In various embodiments, as described in more detail below beginning with reference to FIG. 12, the resizing of the wrap may be performed at the requesting client device, at the server node where the published wrap is maintained, or using a combination of both.

FIG. 12 is a flow diagram describing an embodiment by which a card of a wrap package is automatically sized by the rendering engine 57 for a particular client device. Preferably, these steps occur prior to or as part of step 234 of FIG. 9 before the card is actually displayed upon the device, but may occur at other times.

In a first step 504 the size of the viewport on the device is determined. The viewport refers to the total viewable portion of the screen of the device, and of course, has different sizes and dimensions depending upon whether the device is a mobile phone, a laptop computer, television, etc. Examples of different viewport sizes are shown in FIG. 4 at reference numerals 580-588. The viewport of a given device is dictated by its display screen, which is typically slightly smaller then the outer dimensions of the device. Viewport sizes are measured in pixels, and the viewer 50 present upon the device is able to determine the viewport size in pixels by communicating with the device, such as by making an API call to the browser using JavaScript.

Because pixels on different devices may have different sizes and shapes (e.g., some are square, some are rectangular), a transformation step may optionally be performed in order to conform the viewport size read from the device to a standard (or common) pixel size so that all devices may be treated equally. As is known, most mobile devices and computers use square pixels of a standard size so no transformation step is needed. Televisions, however, may use a rectangular pixel, in which case the transformation step may be used. The result from step 504 is a conforming viewport size in units of standard pixels. For example, a common viewport size of a typical mobile phone (e.g., the iPhone 5) is 640×1136 pixels.

Next, in step 508 the available viewport on the device is determined using the conforming viewport size. Even though a device may have a particular screen size, this does not necessarily mean that all of that screen “real estate” is available for the display of a card of a wrap package. For example, an operating system or browser on a particular device may use certain portions of the top, bottom or side of the screen, meaning that that portion of the screen is not available for display of a card. In one specific example, it is noted that a Microsoft operating system may have a taskbar footprint of 40 pixels, meaning that the vertical dimension of the conforming viewport size needs to be reduced by that amount in order to determine the available viewport size. Further, a Microsoft browser typically uses 25 pixels for a status bar at the bottom and 120 pixels of space at the top of the screen; assuming no vertical browser scrolling bar, the browser may use 4 pixels on the side of the screen. In another example, a conforming viewport size of a typical laptop computer of 1280×800 pixels is reduced to 1260×640 due to the header, footer, and chrome? sizes of a browser. As is known in the art, the borders of a Web browser window, which include the window frames, menus, toolbars, scroll bars, etc., are known as the “chrome.”

Of course, the number of pixels used at the top, bottom or side of the screen depends greatly on the operating system and browser, and on the device itself. On many mobile phones, the entire conforming viewport size is the available viewport size as many applications (including a wrap package) may choose to allow status information shown at the top of the screen (e.g., phone or wireless signal, application icons, battery status, etc.) to overwrite the top portion of any displayed information. Devices other than typical mobile phones and computers (e.g., watches, televisions, kiosks, billboards, etc.) may have other information displayed on the top or sides of the screen that further limits the available viewport size. For example, on laptops a user may change the focus of a window or may resize a window, and that can change the available viewport size. Or, on mobile devices a user may turn their device, thus changing the size. The invention is able to conform to whatever viewport size the user sets (explicitly or implicitly) by employing card size algorithms or letterboxing strategies. Once these restrictions on viewport size (top, bottom or sides) are subtracted from the conforming viewport size, then step 508 produces the available viewport size.

In step 512 the card size is adjusted to fit the available viewport size. For example, if the original card size is 640×910 pixels (having a particular aspect ratio) then the card size may be adjusted upward or downward (keeping the same aspect ratio) if the viewport size is larger or smaller than that original size. Generally, the goal is to make the card size as large as possible, while keeping the same aspect ratio, as long as it fits within the available viewport size. Of course, it may also be necessary to shrink the card size from its original size if the viewport size is smaller.

Thus, the card size is scaled up or down in order to best fill the available viewport size while keeping the aspect ratio the same. While it is possible to choose a custom card size for the screen of each and every device, we have chosen to classify many devices into groups, and then use a particular card size per group. For example, it is noted that for many of the Apple iPhone brand phones (e.g., 5S, 5C and 5), a card size of 640×910 pixels works well. For the smaller format Android platform phones (720 p screen) a card size of 720×1024 pixels works well, and for the larger formats Android platform phones (1080 p screen) a card size of 1080×1536 pixels is the best. For many of the tablet computers (including the iPads by Apple), a card size of 1080×1536 pixels is the best. These are the card sizes for when the phone or tablet is held in its portrait orientation (i.e., it is taller than it is wide). If these devices are turned sideways and held in a landscape orientation, then a different card size works best, but still using the same aspect ratio. Card sizes for these devices in their landscape orientation are: 326×464 for the iPhone phones, 392×558 for smaller format Android, 588×837 for larger format Android, 928×1320 for tablets.

For the majority of laptop computers falling into a group whose common viewport size is 1360×768 pixels, it is found that a card size of 430×612 is best, for many laptop computers the card size should be 520×740, and a card size of 640×910 works well for a smaller number of laptop computers. These are card sizes for the screen of the laptop being in a landscape orientation. Of course, laptop computers are generally viewed with the screen in its landscape orientation and do not have the capability to rotate the image on the screen if the laptop is rotated (most users will not try to rotate a laptop sideways).

Different techniques may be used by the rendering engine 57 to automatically resize a card. FIG. 12 shows two techniques, one via path 514 and the other via path 516, 520.

Via path 514, starting with a desired original card size that has a particular aspect ratio, and knowing the available viewport size, the card is globally expanded or shrunk, while keeping the aspect ratio the same, in order to fill the available viewport. A scale factor may also be determined in this step. For example, if the new card size is 640 by 910 pixels (same as the original) then the scale factor is “1.” If the new card size is half the size of the original card size than the scale factor is “½” or 320 by 455 pixels. In general, the scale factor may be determined by dividing one dimension of the new card size by its corresponding dimension in the original card size, e.g., 1856/910=a scale factor of 2.04 if the wrap package is to be displayed on a tablet computer.

Once a new card size has been determined, the card and its components are resized using the determined scale factor. A variety of techniques may be used to perform this resizing. In one specific embodiment, the rendering engine 57 directs the browser on a particular device to use scaling logic to resize the card and its components using the scale factor. For example, in the course of rendering a particular card, a browser uses HTML and CSS layout rules; in order to adjust the size of the card, the browser may use a CSS transform property. The CSS transform “Scale” is used along with the determined scale factor in order to scale the card (an element) and all of its components. As each component is a child element of the card element, each component will also be scaled accordingly. In this fashion, components may be moved and resized within the new card size in order to preserve the original impression.

Advantageously, any functionality and behavior of a particular component is preserved whether or not the component is made smaller, made larger or stays the same size. Simple components such as text or images may not have functionality, but other more complex components such as buttons, links, videos, etc., retain their unique functionality by virtue of their component description, such as is shown and described in FIG. 6. Once a card has been resized and rendered on a display, the browser of the device will still be able to handle any of the desired functionality such as clicks, scrolls, swipes, data entry, movement, redirection, etc.

In this embodiment in which the CSS transform is used, it is realized that interaction with the ANDROID operating system on certain devices yields odd scrolling behavior when a card is scaled up or down and a user uses his or her finger to scroll a particular component (or, for example a gallery card) within a card of a wrap package. Therefore, in this environment, custom scrolling logic is used to translate between a scaled card (and its components) and the distance a user moves his or her finger on the screen.

Via the alternative path including steps 516 and 520, another technique to resize is used. For example, certain devices such as televisions, projection screens, etc. may not implement a browser, in which case custom layout rules may be written in software in order to perform this resizing of the card and its components, which basically involves moving each component and changing its size.

Steps 516 and 520, explained below, describe the functionality of this software with reference to FIG. 13, which illustrates an example of this technique.

Assuming that a CSS transform is not used and that custom software is used, all of the components within a card are individually moved within the card in light of the new card size in order to preserve the original impression in step 516. In other words, the components are each repositioned such that their original relationships are preserved. In other words, the absolute positions of components within the card may be moved, but their position relative to one another is maintained. For example, if a particular image on the original card size has its center at 100 pixels from the top and 100 pixels from the left hand side, and the new card size has doubled, then the image is moved such that its center is now located at 200 pixels from the top and 200 pixels from the left hand side.

FIG. 13 illustrates movement of an image in order to preserve an impression between different card sizes. Shown is a card 602 having an origin (for example) at point 603 and a “Buy” button 606 whose top left-hand corner is located at 100 pixels from the top and 100 pixels from the left-hand side. An image of an individual 604 is also shown and their relationship is such that the gaze of the individual is directed toward the “Buy” button. If the card size is adjusted in step 512 such that the card size is now twice as large, then card 622 represents that card. Card 622 also has an origin at point 623 and a “Buy” button 626. As described in step 516, this button has been moved such that it top left-hand corner is now 200 pixels from both the top and the left-hand side. In a similar fashion, individual 624 has his position moved within the new card such that his gaze is still directed toward the “Buy” button. One will appreciate that if the “Buy” button 626 remained at the coordinates (100, 100) in card 622 that the impression created in card 602 would be detrimentally affected or altogether lost.

This step is performed for each component within the card. Components 16 are discussed above with reference to FIGS. 5 and 6 and each includes its associated content, source, style, etc. As described therein, each card descriptor 46 also includes a card layout 75 and a layout definition 78. It is within the layout definition that positions of each component are specified and may be changed to accommodate a new card size.

In addition to moving card components, in step 520 the size of all card components within a particular card is changed based upon the new card size. For example, as shown in FIG. 13, when card 602 doubles in size as shown in card 622, each of the components within that card (e.g., “Buy” button 606 and image 604) also double in size. Generally, if the new card size is two and a half times the original card size (for example) then all components will be increased in size by two and a half times, if the new card size is two thirds the original card size (for example) then all components will be reduced in size by two thirds, etc. Thus, the new size of each component is determined based upon the new card size relative to the original card size.

As mentioned above, the cards of a wrap package are not simply bit maps that may be easily resized by resampling. Each card may contain any of a variety of components. For example, types of components include text, image, button, link, etc., masked image, video, glyph, headline, etc., as well as a variety of action components that have a specific functionality when selected such as: location, GPS, transaction, appointments, trigger, etc. If a card is simply treated as a bit map and its components are simply resampled, their functionality and other unique capabilities are lost. The present invention is thus able to change the size of each of these components while retaining their original functionalities and capabilities within a particular card.

By moving card components within the card and by changing their size based upon the new card size (using either a CSS transform or custom software), the relationship between components in the new card size is maintained and the impression is preserved. One way to express the relationship between components is to describe their position and size using a coordinate system relative to an origin of the card, and to require that their relative positions do not change in the new card size. Or, one may express the relationship between components using an angle (such as in a polar coordinate system) and require that that angle does not change in the new card size. For example, the angle of the individual's gaze 604 relative to the button 606 in card 602 does not change in the new card 622, whether measured from the horizontal or from the vertical.

Because the card size has been adjusted to fit the viewport in step 512, and because the aspect ratio remains the same, it is possible there will be extra space on the display screen outside of the new card size but still within the available viewport. In step 524 this remaining space is determined, for example, by taking the available viewport size and subtracting the new card size to obtain both a value in pixels for extra vertical space and a value for extra horizontal space (if any). At this time, the new card size may also be centered within the available viewport. For example, if there is more available space horizontally then the card may be centered horizontally, if there is more available space vertically then the card is centered vertically, or both may occur.

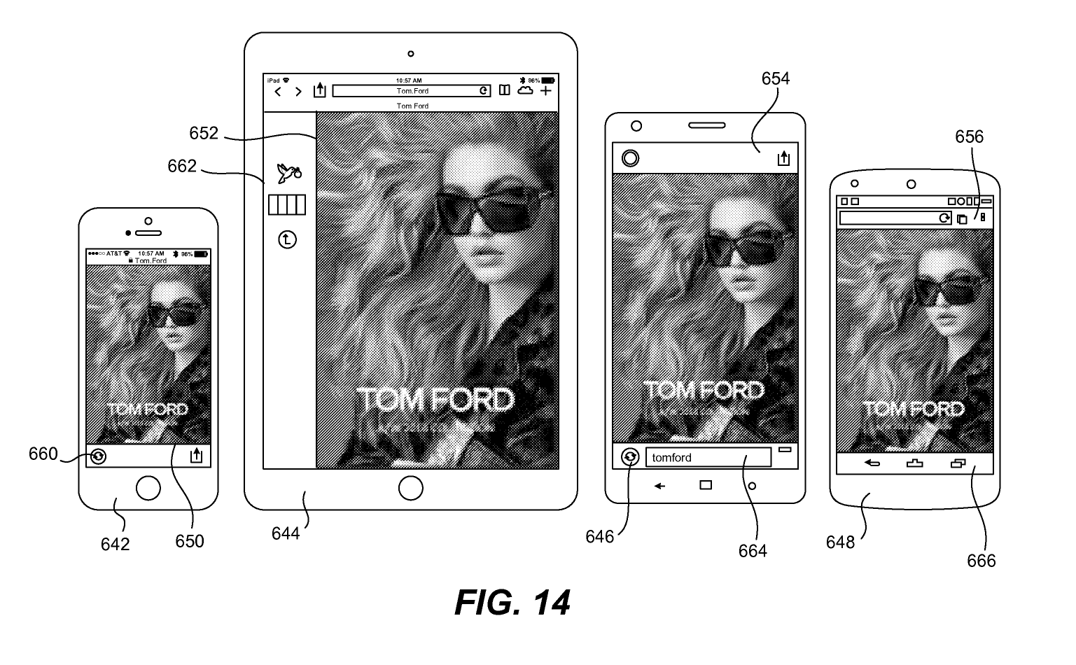

FIG. 14 shows a card from a wrap package displayed on a number of different devices. Shown are devices 642-648 each displaying the same card having a different size but all having the same aspect ratio. Device 642 has extra space at the bottom of its card; device 644 has extra space to the left of its card; device 646 has extra space at the top and bottom; and device 648 has extra space at the top and bottom.

Next, in step 528 the remaining space may be filled with any of a variety of user interface elements, although it is not required that the space be filled with anything. User interface elements include: a background of any color or pattern; navigational elements; functional elements; contextual elements; or a menu. In general, a letterboxing strategy is used when placing the new card size into the available viewport. Navigational elements include icons, buttons or arrows to allow the user to swipe from card to card. Trigger navigational elements are used to trigger a functional Web flow, to initiate a checkout, or to enter other modal or in-place functional flows. Other types of user interface elements include calls to action, status information, alert or account information elements; other functional elements are sharing or saving functions, mixing or other functions specific to the wrap platform, and functions inherited from the native environment for the current user context.

Device 642 shows that a black background 650 has been added to the bottom of the viewport. A black background 652 and 654 has also been added to the left of the card on device 644 and above the card on device 646. A white background 656 has been added above the card on device 648. Navigational elements 660, 662, 664 and 666 have been added, respectively, to devices 642-648.

The type of user interface elements provided in any remaining space may depend upon the type of the device. For example, the touch screen devices shown in FIG. 14 typically are not operated with a pointing device manipulated with a free hand, such as a computer mouse (mainly because the user touches the screen to navigate). But, for a device such as a laptop or desktop computer that does use a computer mouse (or similar), a user interface mouse control may be placed to the left or right of a card in the remaining space and will be useful for navigating through the cards, because the user is not able to touch the screen in order to navigate. Therefore, in one embodiment, devices are categorized as either touch screen enabled or not touch screen enabled. Those with touch screens may not necessarily need user interface elements in the remaining space, whereas those without touch screens will benefit from user interface mouse elements placed in the remaining space.

### Resample Image on Server Computer

Now that automatic sizing on a computing device has been described in detail with reference to FIGS. 12-14, a resampling technique will be described that increases efficiency of the delivery and rendering of wrap packages. This technique can be used in addition to the automatic sizing described above.

FIG. 15 is a flow diagram describing an implementation of step 416 of FIG. 11 in which one or more image(s) in a wrap package are resampled before delivery to the target device. Resampling may occur on wrap server 140, or on another computer where the images are stored.

The rapid pace of imaging technology, especially in mobile phones, means that users are now easily able to take photographs of very high resolution, as high as 8 megapixels or more. And, photographs taken with more traditional cameras can have even higher resolution, meaning that the photographs, images and videos that may be placed within a card of a wrap package when the package is created can have very high resolution. For example, an image used within the authoring tool may have 12 megapixels; it would be inefficient and time consuming to attempt to send this entire image to a mobile phone or other wireless device as part of a wrap package, especially if only a portion of the image is needed. Even an image that is the optimal size and quality for a larger device (such as a tablet computer) would not be suitable for sending to a device such as an iPhone 5S. And, it is not economical to send a high-resolution image to a laptop or desktop computer (for example) when that image will need to be scaled down for display upon that computer.

Accordingly, this embodiment of the invention samples the image or image portion that appears in the card to get a high enough resolution such that the image does not become pixelated on the target device, but has a low enough resolution that allows for the image to be sent quickly and economically to the target device, particularly over a wireless network. This sampling occurs before the wrap package is sent to the device, meaning that only the sufficient amount of data necessary to display the image on the user's device is sent. Although it is possible to create a custom image sample for each and every device on the market, a preferred embodiment creates image samples for certain class sizes of devices, for example, four classes of mobile devices (tablets and phones) and three classes of laptop computers. Delivery of the correct size and resolution for a particular device optimizes data transmission and image quality while preserving the original impression of the card.

FIG. 16 is an example of a portion of an image that appears on a card within a wrap package. Shown is an original high-resolution image 764 of the sole of a shoe that has been obtained for use within card 760 of a wrap package. In the course of creating card 760 within the authoring tool 35, the author determines that only the heel portion 768 is needed for display within the card. Accordingly, the author has defined an image portion 772 that will appear within card 760 during the course of the card creation. Image portion 772 is represented within the authoring tool as a masked image component. Even though the rest of the image will not appear within the card, it is advantageous to keep the entire image 764 upon server 34 for purposes of resampling, and in case the author wishes to redo the card using a different portion of the entire image. It will be appreciated that there is no need to send the entire image 764 to the user's device when only image portion 772 forms parts of card 760.

Referring again to FIG. 15, a first step 704 determines which image or image portion should be resampled. Preferably, the steps of FIG. 15 are performed for all images (or rather, all image components) on each card, and for all cards of a wrap package. If not for all images, then images may be chosen that have a resolution above a certain threshold, that are greater than a certain size, or for which only a portion of the original image is part of a card of a wrap package.

In this simple example, it is determined that image portion 772 is the only image present on card 760 and that it should be resampled to match the target device. It is also noted that even though the original source image 764 has a size of 3000×3000 pixels, that its portion 772 only has a size of 200×200 pixels. Both image 764 and portion 772 have a resolution of 300 DPI (or PPI).

Step 708 determines a matching size and resolution for the target device. Because the target device has already requested a particular wrap package (for example, in step 202) from the wrap server, the wrap server is aware of the specific type of device (e.g., an iPad, the iPhone 6, a specific laptop, etc.), and can thus classify the device into a predetermined device class. As mentioned before, it has been determined that many of the tablets, phones and laptop computers can be grouped into particular classes because they have similar sizes. For example, most tablet computers fall into a one class in which the optimal card size is 1305×1856, the iPhone 5S, 5C and 5 fall into a another class in which the optimal card size is 640×910, and the Android phones fall into yet additional classes in which the optimal card sizes are 800×1137 and 1080×1536 respectively. Laptop computers may fall into one of three classes: a first class in which the optimal card size is 430×612, a second class in which the card size is 512×740, and a third class which the card size is 640×710. As mentioned earlier, all of these card sizes have the same aspect ratio. Of course, other classes may be determined for these devices and other classes may be used for a wide variety of other devices such as desktop computers, televisions, projection screens, etc.

Similar to step 512 above, once the device has been classified by the wrap server, and a scale factor is determined by which the original card size must be increased or decreased, the resampling size can be determined. In addition, the wrap server is aware of the resolution of each of these devices and knows, for example, the resolution of a particular mobile phone. Using image portion 772 as an example, assume that card 760 will be rendered on a much larger device having a resolution of 72 DPI, and requiring that the original card size be increased by a factor of three. This means that image portion 772 with a size of 200×200, must be resampled to have a size of 600×600 and a resolution of 72 DPI.

Next, in step 712 image portion 772 present within card 760 within a particular wrap package on the wrap server is resampled to produce a size and resolution matching the target device. As known in the art, resampling of an image may be performed in different manners, for example, by averaging pixels and then repainting them. The result is a resampled image portion representing image portion 772 that has a size of 600×600 and resolution of 72 DPI that matches not only the resolution of the target device but also the size of the card that will be displayed upon the target device.

In step 716 this resampled image portion will be delivered to the target device along with the rest of the wrap package when delivered.

Of course, the above-described process of FIG. 15 is ideally performed for some or all of the image(s) present within cards of the wrap package whose size are deemed too large to send over a network. In various embodiments, and depending on the circumstances, it is possible that not only will images be increased in size (as in the example above), but also that images may be decreased in size. By not delivering the entire image 764, and by decreasing the resolution, delivery of the image is more economical, which can be beneficial with limited bandwidth networks, such as wireless networks.

Note that once the image has been resampled, it is the appropriate size and resolution for the target device and the browser is aware of this. The resampled image portion thus does not need to be resized in steps 514-520. If, however, the target device needs to use a different size or resolution, the image portion can be resized along with the rest of the card components.

It is possible for the steps of FIG. 15 to occur at different times within the authoring and delivery processes. Although the resampling should happen after the wrap package is published (i.e., after the wrap package has been completed), and should occur before the wrap package is delivered to a target device, the resampling need not necessarily occur after a request has been made. For example, after the wrap package is published, the various images and image portions within cards of the wrap package may be resampled to produce sizes and resolutions for each of those classes of devices, and then cached, in anticipation of requests arriving for the wrap package from those devices. Or, the resampling may occur for a particular class of device when a request arrives from that device. In fact, it is even possible for the steps of FIG. 15 to occur on the device itself instead of on the wrap server, that is, after the wrap package has been delivered to the device, but before the wrap package is displayed on the device, but this would mean transmitting images that may be too large and would mean performing extra processing on the user's device, all of which may have disadvantages.

### Benefits and Advantages of Wrap Packages

Wrap packages 10 offer a number of benefits and attributes currently not available with conventional methods of distributing content, such as with PDFs, web sites, or stand-alone apps, Since cards 14 can be sequenced and authored to include media content, application functionality, and e-commerce related services, wrap packages 10 have the unique ability to narrate a story, in a book-like format, that captures and holds the attention of the viewer, while also offering an “app” like user experience. As such, wrap packages 10 offer a new web-based platform for storytelling, communicating ideas, and delivering highly visual and functional user experiences. Wrap packages 10 thus enable a new business paradigm for selling, advertising, publishing, increasing brand loyalty, offering services, and contacting and engaging new and old customers alike, all ideally delivered to consumers on their mobile devices, where they spend their time and consciousness. Where businesses used to have to build destinations (e.g., websites) or monolithic systems (e.g., “apps”), they can now, instead, provide consumers with wrap packages 10, that are delivered like messages, and that provide the user experiences and functionality they really want and need. As a result, wraps 10 create opportunities for business to innovate and improve products and services, leveraging the mobile web in ways not before possible, because a convenient, enabling interface and platform did not previously exist.

Wrap packages 10 are also like interactive messages that can be easily shared, delivered over the mobile web, and locally stored. With the ability to share, distribute over the mobile web and locally store, popular wrap packages can readily go viral.

Wrap packages 10 are also preferably delivered using a SaaS (Software as a Service) model, meaning wrap packages are delivered only on an as-needed basis.

Wrap packages can be authored by anyone, from individual with little technical or design skills, to large and sophisticated enterprises.

Wrap packages 10 can be distributed narrowly to a specific or targeted person or persons or widely distributed to many, many persons.

Wrap packages 10 can be written once and can run on just about browser enabled device. As a result, wraps are not platform, operating system, or device dependent.

Since wrap packages 10 can be easily generated and optionally dynamically updated with new content, wrap packages can be used as a digital “corollary” or “companion”, accompanying the sale or rental of goods and/or services. For example, wrap packages can be created and distributed as an “Active Receipt” accompanying the sale or rental of a good or service. The merchant can thus provide through the wrap package 10 ongoing contact and support to on-board, up-sell and/or cross-sell the customer with ancillary goods and/or services, potentially for the entire life cycle of the product or service, all delivered in a digital format that never gets lost or misplaced. Accordingly, wrap packages can be used as an essential component of any product or service, delivering better customer service and creating new selling opportunities.

In summary, wrap packages 10 introduce the “narrative web”, which is a storytelling mobile user interface, delivered over a cloud-based platform, ushering in a digital evolution of mobile marketing and customer relationship management. As a marketing tool, wrap packages 10 have the unique ability to increase mobile engagement, lead generation, and conversion, enabling businesses to increase sales, improve loyalty, and enhance customer relationships and loyalty. Wrap packages 10 thus offer a compelling business proposition by solving one of the biggest problems in the mobile space of today; namely the lack of connectivity between apps. With wrap packages 10, however, consumers and other users can enjoy a multi-function app-like experience, without having to be in an app, download an app, or open any apps.

Finally, while many of the benefits and attributes of wrap packages 10 are realized on mobile devices operating on the mobile web, it should be made clear that there is nothing inherent with wrap packages 10 that limit their usefulness or functionality in non-mobile environments. On the contrary, wrap packages 10 can also be used, and all the same benefits and attributes realized, on non-mobile devices, such as desktop computers and/or smart TVs for example.

The present invention is thus intended to be broadly construed to cover any system and method, such as carousel ads for example, that enables publishers and marketers to tell sequenced stories with (i) a combination of images, photos, text, video and other types of media, (ii) a swipe-able format that enables viewers to navigate the media displayed in one screen shot or frame to the next, and (iii) includes embedded app-like functionality and/or links to other locations that provide additional information or such functionality and/or services. Consequently, the present application should not be construed to just those specific embodiments as described herein.

In the primary described embodiments, all of the behaviors are declared rather than being stored in-line within the descriptor. Thus, the descriptor itself does not have any programmable logic. In many embodiments, the declared behavior are all defined within the runtime viewer such that the runtime view can readily associate the desired behavior with the wrap, card or component as appropriate in a runtime instance of the wrap. It should be appreciated that this is a particularly powerful framework for enhancing portability of the wraps. With the descriptor/runtime viewer approach, a single item (the descriptor) can be used to define all of the content and functionality of a set of cards that can be rendered on virtually any platform. The declared functionality is provided (or obtained) by the runtime viewers when the wrap is to be rendered so that the author of the wrap is not required to know or understand any of the idiosyncrasies of any particular platform. The runtime viewer may be a generic runtime viewer (e.g., a viewer executable by a conventional browser) or may be native viewer customized for a particular platform. Regardless of the underlying platform, the runtime viewer handles the tasks of associating the declared behaviors with the wrap/cards/components which frees the wrap author and/or authoring tool from having to ensure that desired behaviors are programmed correctly for all of the different platforms that the wrap may be rendered on.

In most implementations, all of the sizeable assets that serve as content of the wrap are referenced in the wrap by appropriate identifiers rather than being stored directly in the wrap. This again significantly enhances portability by keeping the size of the descriptor small while facilitating the use of rich media content.

From the foregoing it should be apparent that the described wrap packages provide businesses with a powerful tool for engaging their customers, suppliers, employees or other constituents in a format that is particularly well tailored for display on mobile devices.

Although only a few embodiments of the invention have been described in detail, it should be appreciated that the invention may be implemented in many other forms without departing from the spirit or scope of the invention. For example several specific wrap descriptor structures have been described. Although such descriptor structures work well, it should be appreciated that the actual descriptor structure may vary widely. For example, in some embodiments some special behaviors can be defined within a wrap descriptor if desired. Such in-line behavior definition might be particularly useful in association with certain behavior extensions that are not otherwise readily available. For example, JavaScript can be included within a JSON object and various other descriptor structures. Thus, when JSON descriptors are used, selected behaviors or behavior overrides can be defined in-line using JavaScript if desired. Although programmed functionality can be included in some circumstances, it should be appreciated that liberal definition of behaviors within a wrap tends to defeat some of the primary advantages of the described descriptor/runtime viewer framework.

In many implementations much of the actual content of the wrap will be referenced by the descriptor rather than being stored in-line within the descriptor. However, the balance between in-line storage and references to external assets in any particular wrap descriptor may be widely varied anywhere from 100% referenced content to (at least theoretically) 100% in-line content—although the later is less desirable for media rich content and again, begins to defeat some of the advantages of using the descriptor approach. The choice between in-line and referenced content will typically be dictated in large part by the relative size of the content. For example, text, which tends to be very compact, is generally more suitable for inclusion in-line, whereas more graphic media, images, videos and/or audio files are typically more efficiently referenced.

A few different methods of and architectures for serving wrap packages and constructing runtime instances have been described herein. Although only a few approaches have been described in detail, it should be apparent from the foregoing that a wide variety other methods and architectures can be used as well. Therefore, the present embodiments should be considered illustrative and not restrictive and the invention is not to be limited to the details given herein, but may be modified within the scope and equivalents of the appended claims.

We claim:

1. A computer-readable medium comprising computer code for automatically sizing a card for display, said computer code of said computer-readable medium executable by a machine to perform the following:
receiving, over a computer network at a computing device, said card from a computer server, said card having a size and an aspect ratio, said card including a plurality of visual components having spatial relationships with one another;
determining an available size of a viewport on said computing device;
determining a new card size for said card based upon said available viewport size, said new card size also having said aspect ratio;
rendering said visual components within said viewport on said computing device within said new card size; and
maintaining said spatial relationships between said visual components by adjusting size and position of said visual components during said rendering.

2. A medium as recited in claim 1 wherein at least one of said visual components within said received card includes a functionality, said medium further comprising computer code to perform:
maintaining said functionality after said rendering on said viewport of said computing device.

3. A medium as recited in claim 2 wherein said functionality comprises one or the following:
establish an Internet link,
open a chat window,
access a location or GPS service,
click a button,
play a video,
enter data,
perform a transaction,
make an appointment, or
invoke a trigger.

4. A medium as recited in claim 1 further comprising computer code to perform:
performing said maintaining by scaling said visual components using a scale factor within a browser on said computing device.

5. A medium as recited in claim 1, wherein maintaining said spatial relationships further comprises computer code to perform:
moving said visual components based upon said new card size and by changing the size of said visual components based upon said new card size.

6. A medium as recited in claim 1 further comprising computer code to perform:
determining an area of remaining space outside of said new card size but within said viewport; and
placing user interface elements into said area of remaining space.

7. A medium as recited in claim 1 wherein one of said visual components is an image, said method further comprising computer code to perform:
before said receiving, transmitting a request for said card to said computer server, said request including an identification of said computing device; and
receiving, at said computing device, said image having a resolution matching a resolution of said computing device, said image also having a size such that said size of said image need not be adjusted during said rendering.

8. A medium as recited in claim 1 wherein said received card is not a bit map.

9. A medium as recited in claim 1 wherein said card is one of a wrap package of cards.

10. A computer-readable medium comprising computer code for resampling an image, said computer code of said computer-readable medium executable by a machine to perform the following:
receiving a request for a card from a computing device having an available viewport and a resolution;
identifying an image having an image size on said card, said card having a card size and an aspect ratio;
determining a new size for said card that fits within said available viewport and that has said aspect ratio;
determining a new size for said image using a ratio of said new card size to said card size;
resampling said image to produce a new image having said new size and said resolution of said computing device; and
delivering said card from said computer server to said computing device that includes said new image.

11. A medium as recited in claim 10, wherein said card on said computer server includes a plurality of visual components including said image, said visual components having spatial relationships to one another, said medium further comprising computer code to perform:
rendering said visual components in said new card size within said available viewport on said computing device such that said spatial relationships are maintained on said computing device when rendered.

12. A medium as recited in claim 11, said medium further comprising computer code to perform:
performing said rendering by scaling said visual components using a scale factor within a browser on said computing device.

13. A medium as recited in claim 11, said medium further comprising computer code to perform:
performing said rendering by moving said visual components based upon said new card size and by changing the size of said visual components based upon said new card size.

14. A medium as recited in claim 10 wherein said delivered card is not a bit map.

15. A medium as recited in claim 10 wherein said delivered card is one of a wrap package of cards.

16. A computer-readable medium comprising computer code for displaying an image, said computer code of said computer-readable medium executable by a machine to perform the following:
requesting, from a computer server, a card to be displayed on said computing device, said computing device having an available viewport and a screen resolution;
receiving, over a computer network at said computing device, said card from a computer server, said card having a card size and an aspect ratio, said card including a plurality of visual components having spatial relationships with one another, and wherein one of said visual components is an image having an image size and said screen resolution;
changing said card size to a new card size that fits within said available viewport and that has said aspect ratio;
rendering said visual components within said available viewport on said computing device within said new card size, wherein said spatial relationships are maintained; and
not changing said image size during said rendering nor said screen resolution of said image.

17. A medium as recited in claim 16, said method further comprising computer code to perform:
performing said rendering by scaling said visual components using a scale factor within a browser on said computing device.

18. A medium as recited in claim 16 further comprising computer code to perform:
performing said rendering by moving said visual components based upon said new card size and by changing the size of said visual components based upon said new card size.

19. A medium as recited in claim 16 wherein said delivered card is not a bit map.

20. A medium as recited in claim 16 wherein said delivered card is one of a wrap package of cards.
